(19) United States
(12) Patent Application Publication
(10) Pub. No.: US 2008/0043209 A1
(43) Pub. Date: Feb. 21, 2008

(54) Image display system with channel selection device

(76) Inventors: Simon Widdowson, Palo Alto, CA (US); Nelson Liang An Chang, Palo Alto, CA (US); Niranjan Damera-Venkata, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/506,566

(22) Filed: Aug. 18, 2006

(51) Int. Cl. G03B 21/26

(52) U.S. Cl. 353/94

(57) ABSTRACT

An image display system includes a first projector configured to project a first sub-frame onto a display surface to form at least a portion of a first image, a second projector configured to project a second sub-frame onto the display surface simultaneous with the projection of the first sub-frame to form at least a portion of a second image, the second sub-frame at least partially overlapping with the first image on the display surface, and a channel selection device configured to simultaneously allow a viewer to see the first image and prevent the viewer from seeing the second image.

### CROSS-REFERENCE TO RELATED APPLICATION

This application is related to U.S. patent application Ser. No. 11/080,583, filed Mar. 15, 2005, and entitled PROJECTION OF OVERLAPPING SUB-FRAMES ONTO A SURFACE; and U.S. patent application Ser. No. 11/080,223, filed Mar. 15, 2005, and entitled PROJECTION OF OVERLAPPING SINGLE-COLOR SUB-FRAMES ONTO A SURFACE. These applications are incorporated by reference herein.

### BACKGROUND

Two types of projection display systems are digital light processor (DLP) systems, and liquid crystal display (LCD) systems. It is desirable in some projection applications to provide a high lumen level output, but it can be very costly to provide such output levels in existing DLP and LCD projection systems. Three choices exist for applications where high lumen levels are desired: (1) high-output projectors; (2) tiled, low-output projectors; and (3) superimposed, low-output projectors.

When information requirements are modest, a single high-output projector is typically employed. This approach dominates digital cinema today, and the images typically have a nice appearance. High-output projectors have the lowest lumen value (i.e., lumens per dollar). The lumen value of high output projectors is less than half of that found in low-end projectors. If the high output projector fails, the screen goes black. Also, parts and service are available for high output projectors only via a specialized niche market.

Tiled projection can deliver very high resolution, but it is difficult to hide the seams separating tiles, and output is often reduced to produce uniform tiles. Tiled projection can deliver the most pixels of information. For applications where large pixel counts are desired, such as command and control, tiled projection is a common choice. Registration, color, and brightness must be carefully controlled in tiled projection. Matching color and brightness is accomplished by attenuating output, which costs lumens. If a single projector fails in a tiled projection system, the composite image is ruined.

Superimposed projection provides excellent fault tolerance and full brightness utilization, but resolution is typically compromised. Algorithms that seek to enhance resolution by offsetting multiple projection elements have been previously proposed. These methods assume simple shift offsets between projectors, use frequency domain analyses, and rely on heuristic methods to compute component sub-frames. The proposed systems do not generate optimal sub-frames in real-time, and do not take into account arbitrary relative geometric distortion between the component projectors. In addition, the superimposed projection of unrelated images may result in a distorted appearance.

### SUMMARY

One form of the present invention provides an image display system including a first projector configured to project a first sub-frame onto a display surface to form at least a portion of a first image, a second projector configured to project a second sub-frame onto the display surface simultaneous with the projection of the first sub-frame to form at least a portion of a second image, the second sub-frame at least partially overlapping with the first image on the display surface, and a channel selection device configured to simultaneously allow a viewer to see the first image and prevent the viewer from seeing the second image.

### BRIEF DESCRIPTION OF THE DRAWINGS

FIG. 1 is a block diagram illustrating an image display system according to one embodiment of the present invention.

FIGS. 2A-2C are block diagrams illustrating the viewing of subsets of images on a display surface.

FIGS. 3A-3D are block diagrams illustrating embodiments of channel selection devices.

FIGS. 4A-4B are graphical diagrams illustrating the operation of the embodiment of the channel selection device of FIG. 3A.

FIGS. 5A-5D are schematic diagrams illustrating the projection of four sub-frames according to one embodiment of the present invention.

FIG. 6 is a diagram illustrating a model of an image formation process according to one embodiment of the present invention.

FIG. 7 is a diagram illustrating a model of an image formation process according to one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., may be used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

### I. Channel Selection from at Least Partially Overlapping Images

As described herein, a system for viewing different subsets of images from a set of simultaneously displayed and at least partially overlapping images by different viewers is provided. The system includes two or more subsets of projectors, where each of the subset of projectors simultaneously projects a different image onto a display surface in positions that at least partially overlap, and a channel selection device. The channel selection device allows different subsets of the projected images (also referred to herein as channels) to be viewed by different viewers. To do so, the channel selection device causes a subset of the images to be viewed by each viewer while preventing another subset of the images from being seen by each viewer. The channel select device may also allow the full set of images to be viewed by one or more viewers as a channel while other viewers are viewing only a subset of the images. Accordingly, different viewers viewing the same display surface at the same time may see different content in the same location on the display surface.

Each subset of projectors includes one or more projectors. Where a subset of projectors includes two or more projectors, each projector projects a sub-frame formed according to a geometric relationship between the projectors in the subset. The images may each be still images that are displayed for a relatively long period of time, video images from video streams that are displayed for a relatively short period of time, or any combination of still and video images. In addition, the images may be fully or substantially fully overlapping (e.g., superimposed on one another), partially overlapping (e.g., tiled where the images have a small area of overlap), or any combination of fully and partially overlapping. Further, the area of overlap between any two images in the set of images may change spatially, temporally, or any combination of spatially and temporally.

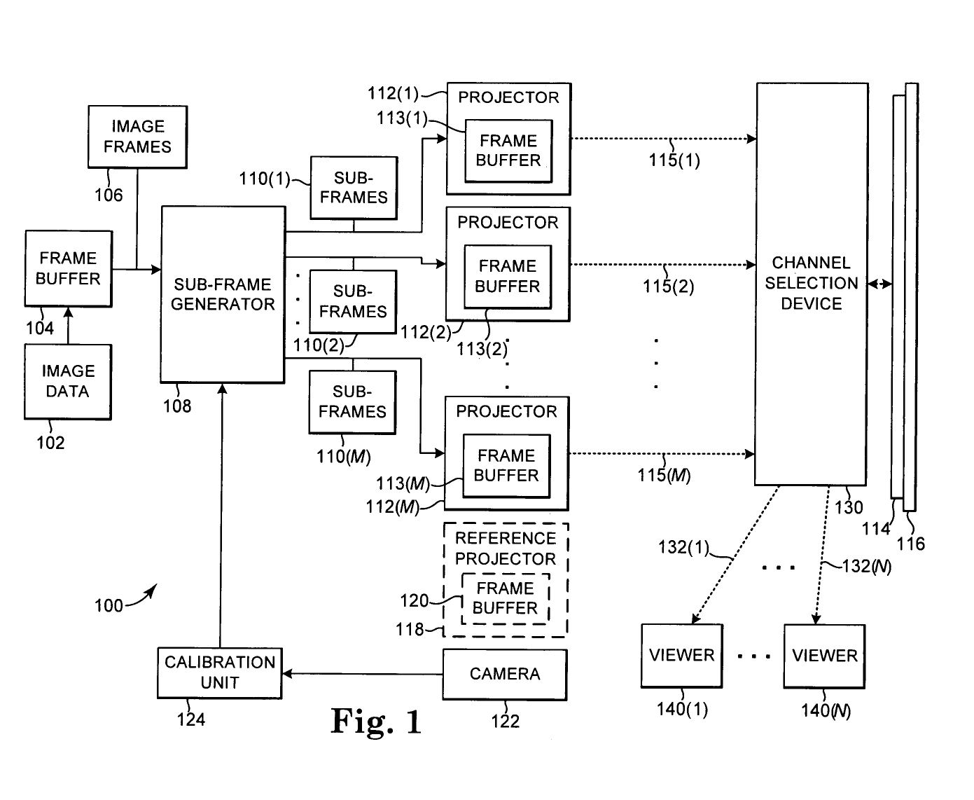

FIG. 1 is a block diagram illustrating an image display system 100 according to one embodiment. Image display system 100 includes image frame buffer 104, sub-frame generator 108, projectors 112(1)-112(M) where M is an integer greater than or equal to two (collectively referred to as projectors 112), one or more cameras 122, calibration unit 124, and a channel selection device 130.

Image display system 100 processes one or more sets of image data 102 and generates a set of displayed images 114 on a display surface 116 where at least two of the displayed images are displayed in at least partially overlapping positions on display surface 116.

Displayed images 114 are defined to include any combination of pictorial, graphical, or textural characters, symbols, illustrations, or other representations of information. Displayed images 114 may each be still images that are displayed for a relatively long period of time, video images from video streams that are displayed for a relatively short period of time, or any combination of still and video images. In addition, at least two of the set of displayed images 114 are fully overlapping (e.g., superimposed on one another; or one image fully contained within another image), substantially fully overlapping (e.g., superimposed with a small area that does not overlap), or partially overlapping (e.g., partially superimposed; or tiled where the images have a small area of overlap) either continuously or at various times. Other images in the set of displayed images 114 may also overlap by any degree with or be separated from the overlapping images in the set of displayed images 114. Any area of overlap or separation between any two images in the set of displayed images 114 may change spatially, temporally, or any combination of spatially and temporally.

A channel selection device 130 is configured to allow different subsets 132(1)-132(N) (collectively referred to as subsets 132) of the at least partially overlapping images 114 to be simultaneously viewed by viewers 140(1)-140(N) (collectively referred to as viewers 140) on display surface 116 where N is an integer greater than or equal to two. Subset 132 may also refer to the entire set of displayed images. Accordingly, different viewers 140 viewing display surface 116 at the same time may see different subsets 132 of images 114. Subsets 132 are also referred to herein as channels when describing what viewers 140 see. Although shown in FIG. 1 as being between both projectors 112 and display surface 116 and display surface 116 and viewers 140, channel selection device 130 may not actually be between projectors 112 and display surface 116 in some embodiments.

Image frame buffer 104 receives and buffers sets of image data 102 to create sets of image frames 106. In one embodiment, each set of image data 102 corresponds to a different image in the set of displayed images 114 and each set of image frames 106 is formed from a different set of image data 102. In another embodiment, each set of image data 102 corresponds to one or more than one of the images in the set of displayed images 114 and each set of image frames 106 is formed from one or more than one set of image data 102. In a further embodiment, a single set of image data 102 may correspond to all of the images in the set of displayed images 114 and each set of image frames 106 is formed from the single set of image data 102.

Sub-frame generator 108 processes the sets of image frames 106 to define corresponding image sub-frames 110(1)-110(M) (collectively referred to as sub-frames 110) and provides sub-frames 110(1)-110(M) to projectors 112(1)-112(M), respectively. Sub-frames 110 are received by projectors 112, respectively, and stored in image frame buffers 113(1)-113(M) (collectively referred to as image frame buffers 113), respectively. Projectors 112(1)-112(M) project the sub-frames 110(1)-110(M), respectively, to produce video image streams 115(1)-115(M) (individually referred to as a video stream 115 or collectively referred to as video streams 115), respectively, that project through or onto channel selection device 130 and onto display surface 116 to produce the set of displayed images 114. Each image in the set of displayed images 114 is formed from a subset of sub-frames 110(1)-110(M) projected by a respective subset of projectors 112(1)-112(M). For example, sub-frames 110(1)-110(i) may be projected by projectors 112(1)-112(i) to form a first image in the set of displayed images 114, and sub-frames 110(i+1)-110(M) may be projected by projectors 112(i+1)-112(M) to form a second image in the set of displayed images 114 where i is an integer index from 1 to M that represents the ith sub-frame 110 in the set of sub-frames 110(1)-110(M) and the ith projector 112 in the set of projectors 112(1)-112(M).

Projectors 112 receive image sub-frames 110 from sub-frame generator 108 and simultaneously project the image sub-frames 110 onto display surface 116. As noted above, different subsets of projectors 112(1)-112(M) form different images in the set of displayed images 114 by projecting respective subsets of sub-frames 110(1)-110(M). The subsets of projectors 112 project the subsets of sub-frames 110 such that the set of displayed images 114 appears in any suitable superimposed, tiled, or separated arrangement, or combination thereof, on display surface 116 where at least two of the images the set of displayed images 114 at least partially overlap.

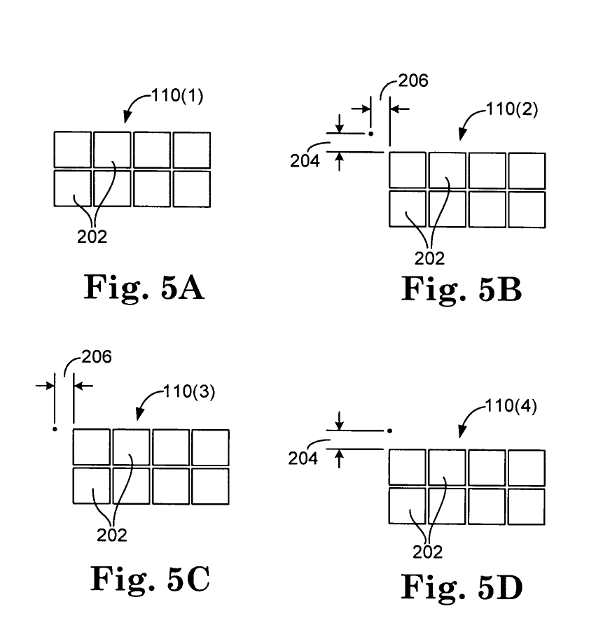

Each image in displayed images 114 may be formed by a subset of projectors 112 that include one or more projectors 112. Where a subset of projectors 112 includes one projector 112, the projector 112 in the subset projects a sub-frame 110 onto display surface 116 to produce an image in the set of displayed images 114.

Where a subset of projectors 112 includes more than one projector 112, the subset of projectors 112 simultaneously project a corresponding subset of sub-frames 110 onto display surface 116 at overlapping and spatially offset positions to produce an image in the set of displayed images 114. An example of a subset of sub-frames 110 projected at overlapping and spatially offset positions to form an image in the set of displayed images 114 is described with reference to FIGS. 5A-5D below.

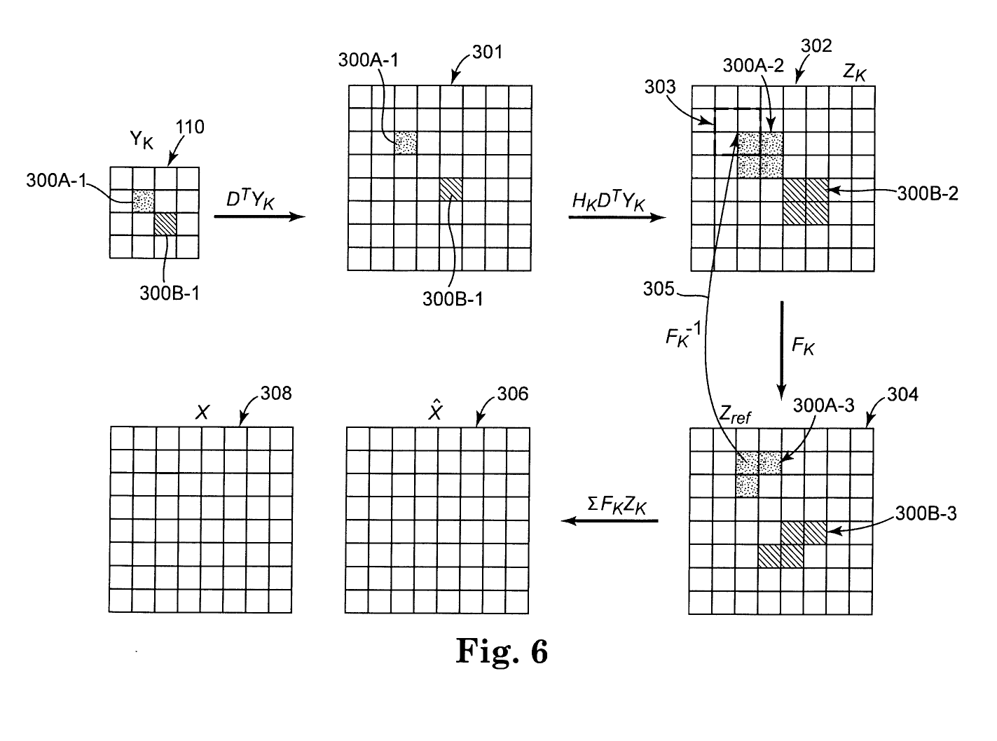

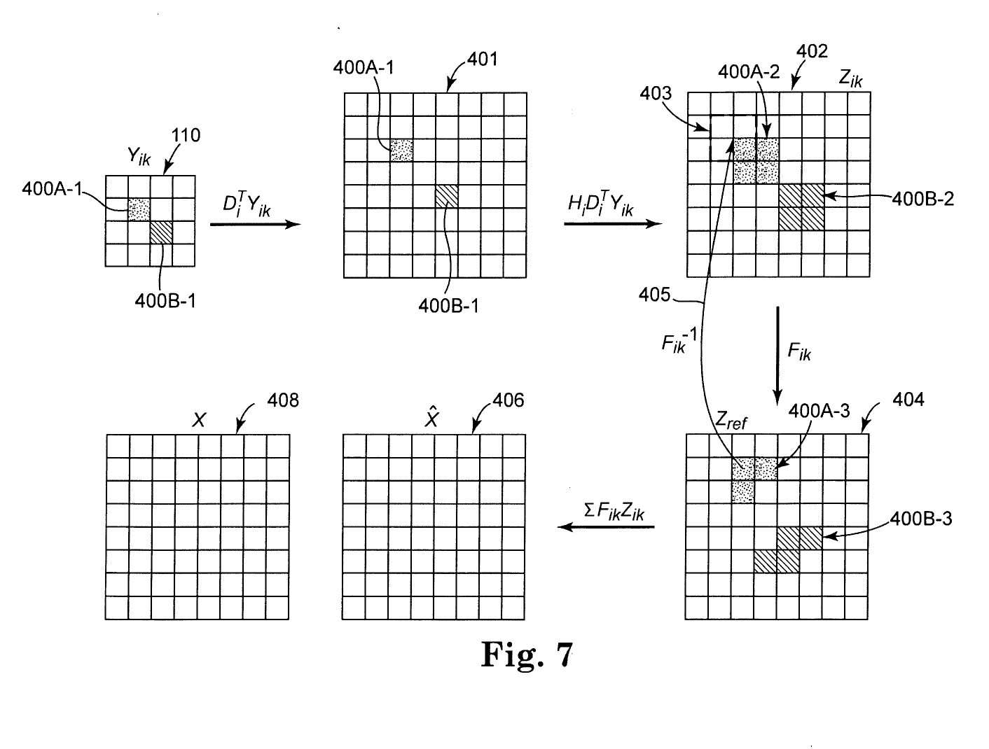

Sub-frame generator 108 forms each subset of two or more sub-frames 110 according to a geometric relationship between each of the projectors 112 in a given subset as described in additional detail below with reference to the embodiments of FIGS. 6 and 7. With the embodiment of FIG. 6, sub-frame generator 108 forms each of the subset of sub-frames 110 in full color and each projector 112 in a subset of projectors 112 projects sub-frames 110 in full color. With the embodiment of FIG. 7, sub-frame generator 108 forms each of the subset of sub-frames 110 in a single color (e.g., red, green, or blue), each projector 112 in a subset of projectors 112 projects sub-frames 110 in a single color, and the subset of projectors 112 includes at least one projector 112 for each desired color (e.g., at least three projectors 112 for the set of red, green, and blue colors).

In one embodiment, image display system 100 attempts to determine appropriate values for the sub-frames 110 so that each image in the set of displayed images 114 produced by the projected sub-frames 110 is close in appearance to how a corresponding high-resolution image (e.g., a corresponding image frame 106) from which the sub-frame or sub-frames 110 were derived would appear if displayed directly.

Also shown in FIG. 1 is reference projector 118 with an image frame buffer 120. Reference projector 118 is shown with dashed lines in FIG. 1 because, in one embodiment, projector 118 is not an actual projector but rather a hypothetical high-resolution reference projector that is used in an image formation model for generating optimal sub-frames 110, as described in further detail below with reference to the embodiments of FIGS. 6 and 7. In one embodiment, the location of one of the actual projectors 112 in each subset of projectors 112 is defined to be the location of the reference projector 118.

Display system 100 includes at least one camera 122 and calibration unit 124, which are used to automatically determine a geometric relationship between each projector 112 in each subset of projectors 112 and the reference projector 118, as described in further detail below with reference to the embodiments of FIGS. 6 and 7.

Channel selection device 130 is configured to allow different subsets in the set of displayed images 114 to be viewed by different viewers 140. To do so, channel selection device 130 causes a subset of the set of displayed images 114 to be viewed by each viewer 140 while simultaneously preventing another subset of the set of displayed images 114 from being seen by each viewer 140. Channel selection device 130 may also be configured to allow selected users to view the entire set of displayed images 114 without preventing any of the images in set of displayed images 114 from being seen by the selected viewers. Accordingly, different viewers 140 viewing the same portion of display surface 116 at the same time may see different subsets of the set of displayed images 114 or the entire set of displayed images 114.

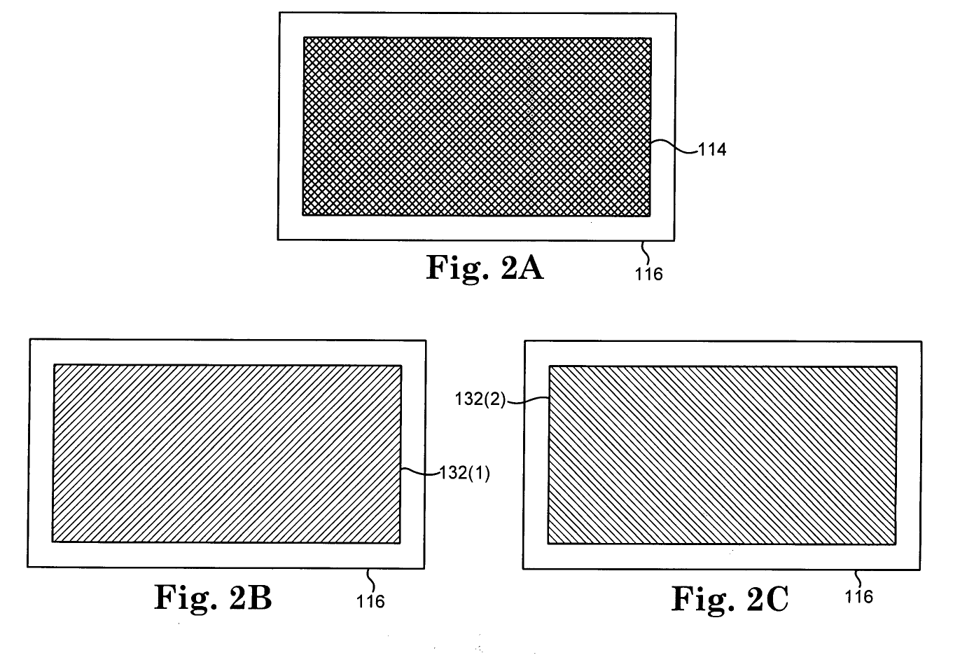

FIGS. 2A-2C are block diagrams illustrating an example of viewing subsets 132 of the set of displayed images 114 on display surface 116 by different users 140. FIG. 2A illustrates the display of the set of displayed images 114 where the set includes at least two images that fully overlap.

When viewed without channel selection device 130, the set of displayed images 114 may appear distorted to viewers 140 where the content of two or more of the images that overlap are unrelated or independent of one another. For example, if one of the images is from a first television channel and another of the images is from a second, unrelated television channel, the overall appearance of the set of displayed images 114 may be distorted and unwatchable in the region of overlap.

If the content of the overlapping images are related, dependent upon one another, or complementary, then the overall appearance of the set of displayed images 114 may be undistorted in the region of overlap. For example, if one of the images is from a movie without visual enhancements and another of the images is from the same movie with visual enhancements (e.g., sub-titles, notes of explanation, additional, alterative, or selected audience content, etc.), then the full set of displayed images 114 may be viewed by one or more viewers 140 without distortion.

FIGS. 2B and 2C illustrates the display of subset 132(1) and 132(2), respectively, of the set of displayed images 114 using channel selection device 130. Subsets 132(1) and 132(2) appear differently to viewers 140(1) and 140(2), respectively, than the full set of displayed images 114 shown in FIG. 2A. In addition, subset 132(1) appears differently to viewer 140(1) than subset 132(2) appears differently to viewer 140(2).

If the overlapping images in the set of displayed images 114 are unrelated or independent, channel selection device 130 eliminates the distortion caused by the overlapping images by simultaneously allowing viewers 140(1) and 140(2) to view subsets 132(1) and 132(2), respectively, and preventing viewers 140(1) and 140(2) from seeing unrelated or independent subsets of overlapping images in the set of displayed images 114. As a result, subsets 132(1) and 132(2) appear undistorted and watchable by viewers 140(1) and 140(2), respectively. In the example set forth above for unrelated or independent overlapping images, channel selection device 130 may cause subset 132(1) to include the first television channel, but not the second, unrelated television channel so that viewer 140(1) sees only the first television channel. Similarly, channel selection device 130 may cause subset 132(2) to include the second television channel, but not the first, unrelated television channel so that viewer 140(2) sees only the second television channel.

If the overlapping images in the set of displayed images 114 are related, dependent, or complementary, channel selection device 130 prevents different subsets of the overlapping images from being seen by viewers 140(1) and 140(2), respectively. Each subset 132(1) and 132(2) appears undistorted and fully watchable by viewers 140(1) and 140(2), respectively. Each subset 132(1) and 132(2), however, includes a different subset of images from the set of displayed images 114. In the example set forth above for related, dependent, or complementary overlapping images, channel selection device 130 may cause each subset 132(1) and 132(2) to selectively include a different subset of visual enhancements in a movie that appear in the display of the full set of displayed images 114. For example, subset 132(1) may include images that form additional content for mature audiences but not images that form sub-titles. Similarly, subset 132(2) may include the images that form the sub-titles but not the images that form the content for mature audiences. A third subset 132(3) (not shown in FIG. 2C) may not include either the images that form the sub-titles or the images that form the content for mature audiences.

FIGS. 2A-2C illustrate one example of providing different subsets 132 to different users 140 where at least two images fully overlap. Many other image arrangements are possible. For example, one subset 132(1) may include a full-screen, superimposed display of a subset of images from the set of displayed images 114 formed from one or more subsets of video streams 115, and another subset 132(2) may include a tiled display with any number of subsets of images from the set of displayed images 114 formed from any number of subsets of video streams 115. A further subset 132(3) may include any combination of a superimposed and tiled display with any number of subsets of images from the set of displayed images 114 formed from any number of subsets of video streams 115.

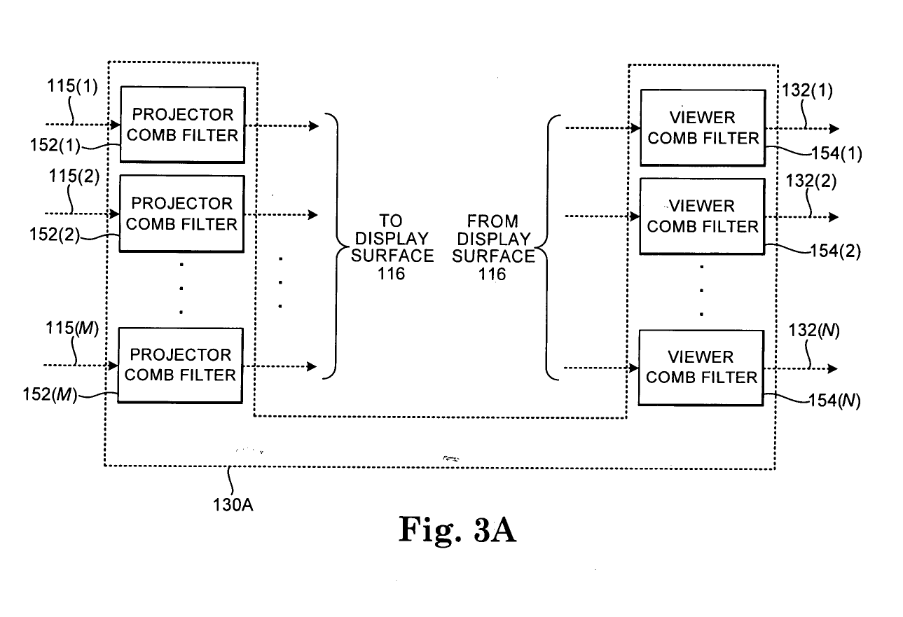

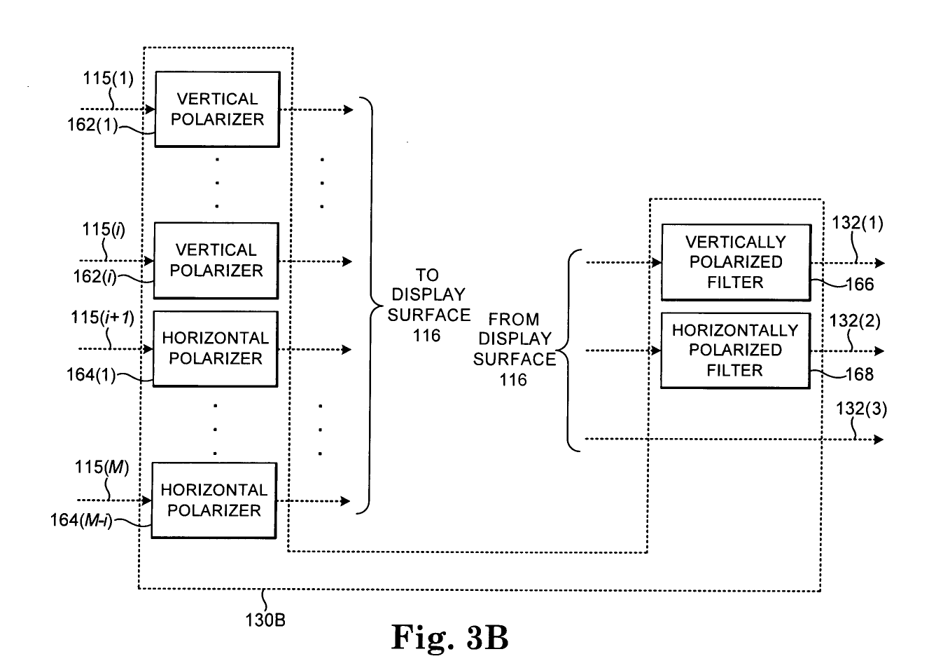

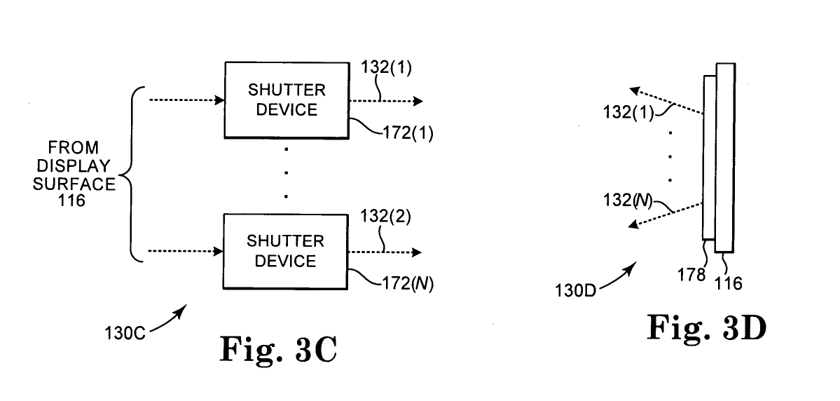

Referring back to FIG. 1, channel selection device 130 receives the video streams 115 from projectors 112 and provides subsets 132 of the set of displayed images 114 to viewers 140. As illustrated in the embodiments of channel selection device 130 in FIGS. 3A-3D, channel selection device 130 may include multiple components that, depending on the embodiment, are included with or adjacent to projectors 112, positioned between projectors 112 and display surface 116, included in or adjacent to display surface 116, positioned between display surface 116 and viewers 140, or worn by viewers 140. Channel selection device 130 may operate by providing different light frequency spectra to different users 140, providing different light polarizations to different users 140, providing different pixels to different users 140, or providing different content to different users 140 at different times.

FIGS. 3A-3D are block diagrams illustrating embodiments 130A-130D, respectively, of channel selection device 130.

In FIG. 3A, channel selection device 130A includes projector comb filters 152(1)-152(M) (collectively referred to as projector comb filters 152) for projectors 112(1)-112(M), respectively, and viewer comb filters 154(1)-154(N) (collectively referred to as viewer comb filters 154) for viewers 140(1)-140(N), respectively.

Projector comb filters 152 are each configured to filter selected light frequency ranges in the visible light spectrum from respective projectors 112. Accordingly, projector comb filters 152 pass selected frequency ranges from respective projectors 112 and block selected frequency ranges from respective projectors 112. Projector comb filters 152 receive video streams 115, respectively, filter selected frequency ranges in video streams 115, and transmit the filtered video streams onto display surface 116.

Along with projectors 112, projector comb filters 152 are divided into subsets where each projector comb filters 152 in a subset is configured to filter the same frequency ranges and different subsets are configured to filter different frequency ranges. The frequency ranges of different subsets may be mutually exclusive may partially overlap with the frequency ranges in another subset. For example, a first subset of projector comb filters 152 may include projector comb filters 152(1)-152(i) that filter a first set of frequency ranges (where i is an integer index from 1 to M-1 that represents the ith projector comb filter 152 in the set of projector comb filters 152(1)-152(M-1)), and a second set of projector comb filters 152 may include projector comb filters 152(i+1)-152(M) that filter a second set of frequency ranges that differs from the first set of frequency ranges. In addition, the frequency ranges of different subsets of projector comb filters 152 may vary over time such that the specific frequency range of each subset varies as a function of time.

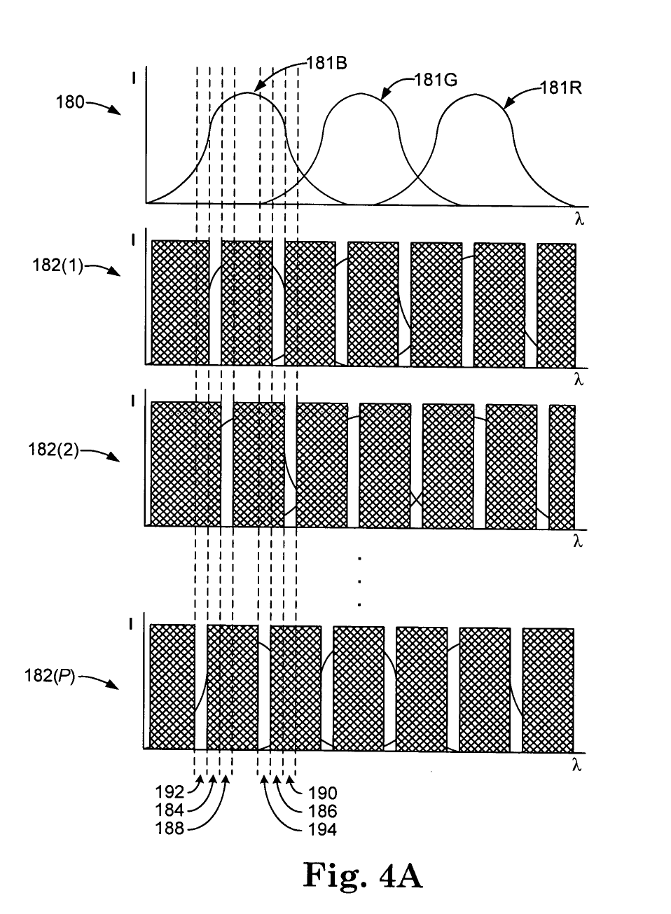

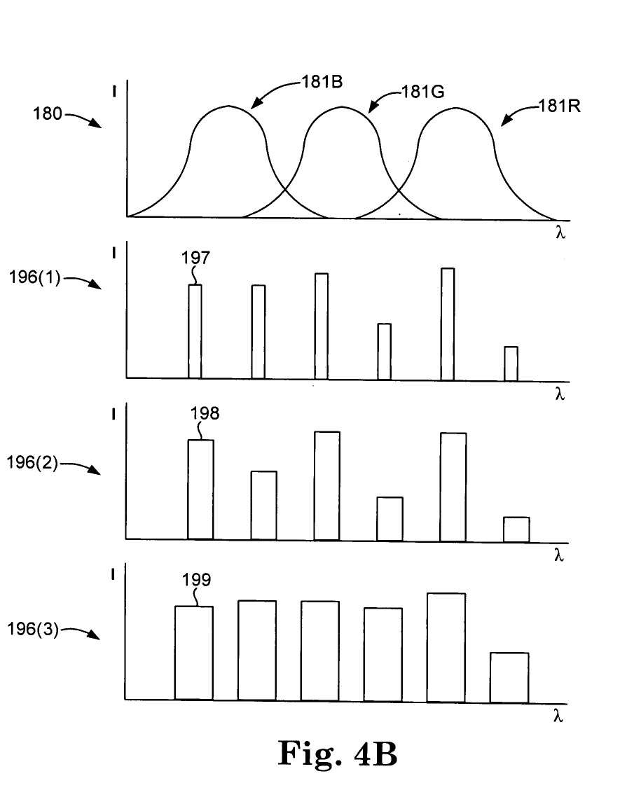

FIG. 4A is a graphical diagram illustrating an example of the operation of subsets of projector comb filters 152. A graph 180 illustrates the intensity of light for a range of light wavelengths in the visible spectrum to form white light. A curve 181B represents an approximation of the blue light wavelengths with a peak at approximately 475 nm, a curve 181G represents an approximation of the green light wavelengths with a peak at approximately 510 nm, and a curve 181R represents an approximation of the red light wavelengths with a peak at approximately 650 nm. Graphs 182(1)-182(P) illustrate the wavelengths ranges filtered by P subsets of projector comb filters 152 where P is an integer that is greater than or equal to two and less than or equal to M.

Graph 182(1) illustrates the wavelengths ranges filtered by a first subset of projector comb filters 152. The shaded regions indicate wavelengths ranges that are filtered by the first subset. As shown, the first subset passes portions of the wavelength range for each color (blue, green, and red). For example, the first subset passes a range of wavelengths 182 and a range of wavelengths 184 in the blue light wavelength range. Similar ranges of wavelengths are passed in the green and red light wavelengths ranges.

Graph 182(2) illustrates the wavelengths ranges filtered by a second subset of projector comb filters 152. The shaded regions indicate wavelengths ranges that are filtered by the second subset. As shown, the second subset passes portions of the wavelength range for each color (blue, green, and red). For example, the second subset passes a range of wavelengths 188 and a range of frequencies 190 in the blue light wavelength range. Similar ranges of frequencies are passed in the green and red light wavelengths ranges.

Graph 182(P) illustrates the wavelengths ranges filtered by a Pth subset of projector comb filters 152. The shaded regions indicate wavelengths ranges that are filtered by the Pth subset. As shown, the Pth subset passes portions of the wavelength range for each color (blue, green, and red). For example, the Pth subset passes a range of wavelengths 192 and a range of wavelengths 194 in the blue light wavelength range. Similar ranges of wavelengths are passed in the green and red light wavelengths ranges.

FIG. 4A illustrates one example configuration of the wavelength ranges filtered by projector comb filters 154. In other configurations, any other suitable combination of wavelength ranges may be filtered by projector comb filters 154. In addition, the wavelength ranges may be also described in terms of frequency ranges.

Referring back to FIG. 3A, projector comb filters 152 may be integrated with projectors 112 (e.g., inserted into the projection paths of projectors 112 or formed as part of specialized color wheels that transmit only the desired frequency ranges) or may be adjacent or otherwise external to projectors 112 in the projection path between projectors 112 and display surface 116.

Using subsets of projector comb filters 152, subsets of projectors 112 form different images in the set of displayed images 114 where each of the different images is formed using different ranges of light frequencies.

Viewer comb filters 154 are each configured to filter selected ranges of light frequency in the visible light spectrum from display surface 116. Accordingly, viewer comb filters 154 pass selected frequency ranges from display surface 116 and block selected frequency ranges from display surface 116 to allow viewers 140 to see a selected subset of the set of displayed images 114. Viewer comb filters 154 receive the filtered video streams from display surface 116, filter selected frequency ranges in the filtered video streams to form subsets 132 of the set of displayed images 114, and transmit subsets 132 to viewers 140. A viewer comb filter 154 may also be configured to pass all frequency ranges to form a subset 132 and allow a viewer 140 to see the entire set of displayed images 114.

The frequency ranges filtered by each viewer comb filter 154 corresponds to one or more subsets of projector comb filters 152. Accordingly, a viewer 140 using a given comb filter 154 views the images in the set of displayed images 114 that correspond to one or more subsets of projectors 112 with projector comb filters 152 that pass the same frequency ranges as the given comb filter. The frequency ranges filtered by each viewer comb filter 154 may vary over time and may be synchronized with one or more different subsets of projector comb filters 152 that also vary over time.

FIG. 4B is a graphical diagram illustrating an example of the operation of example viewer comb filters 154(1), 154(2), and 154(3). Graphs 196(1)-196(3) illustrate the wavelengths ranges passed by viewer comb filters 154(1), 154(2), and 154(3), respectively.

The block regions of graph 196(1) illustrate the wavelengths ranges passed by viewer comb filter 154(1). As shown, viewer comb filter 154(1) passes portions of the wavelength range for each color (blue, green, and red). For example, viewer comb filter 154(1) passes a range of wavelengths 197 in the blue light wavelength range. At least one range of wavelengths is passed in each of the blue, green, and red color bands. Referring back to FIG. 4A, the wavelength ranges passed by viewer comb filter 154(1) corresponds to the first subset of projector comb filters 152. Accordingly, viewer 140(1) sees the images projected by the subset of projectors 112 with the first subset of projector comb filters 152 by using the by viewer comb filter 154(1). Because viewer comb filter 154(1) only passes the wavelength ranges projected by the first subset of projectors 112, viewer 140(1) does not see any images projected by the subsets of projectors 112 that use the second or Pth subsets of projector cone filters 152.

Referring to FIG. 4B, the block regions of graph 196(2) illustrate the wavelengths ranges passed by viewer comb filter 154(2). As shown, viewer comb filter 154(2) passes portions of the wavelength range for each color (blue, green, and red). For example, viewer comb filter 154(2) passes a range of wavelengths 198 in the blue light wavelength range. At least one range of wavelengths is passed in each of the blue, green, and red color bands. Referring back to FIG. 4A, the wavelength ranges passed by viewer comb filter 154(2) corresponds to the first and the second subsets of projector comb filters 152. Accordingly, viewer 140(2) sees the images projected by the subset of projectors 112 with the first subset of projector comb filters 152 and the subset of projectors 112 with the second subset of projector comb filters 152 by using the by viewer comb filter 154(2). Because viewer comb filter 154(2) only passes the wavelength ranges projected by the first and second subsets of projectors 112, viewer 140(2) does not see any images projected by the subset of projectors 112 that use the Pth subset of projector cone filters 152.

Referring to FIG. 4B, the block regions of graph 196(3) illustrate the wavelengths ranges passed by viewer comb filter 154(3). As shown, viewer comb filter 154(3) passes portions of the wavelength range for each color (blue, green, and red). For example, viewer comb filter 154(3) passes a range of wavelengths 199 in the blue light wavelength range. At least one range of wavelengths is passed in each of the blue, green, and red color bands. Referring back to FIG. 4A, the wavelength ranges passed by viewer comb filter 154(3) corresponds to the first, the second, and the Pth subsets of projector comb filters 152. Accordingly, viewer 140(3) sees the images projected by the subset of projectors 112 with the first subset of projector comb filters 152, the subset of projectors 112 with the second subset of projector comb filters 152, and the subset of projectors 112 with the Pth subset of projector comb filters 152 by using the by viewer comb filter 154(3).

FIG. 4B illustrates one example configuration of the wavelength ranges passed by viewer comb filters 152. In other configurations, any other suitable combination of wavelength ranges may be passed by viewer comb filters 152. In addition, the wavelength ranges may be also described in terms of frequency ranges.

With the embodiment of FIG. 3A, at least a portion of each color red, green, and blue are viewed by each viewer 140. Accordingly, images on display surface 116 may be viewed by viewers 140 with minimal loss of color gamut. In addition, each subset 132 may be displayed by a corresponding subset or subsets of projectors 112 at a full frame rate. In addition, each viewer comb filter 154 may be adjusted by a viewer 140 to select which subset 132 or the entire set of displayed images for viewing at any given time.

In one embodiment, each viewer comb filter 154 may be included in glasses or a visor that fits on the face of a viewer 140. In other embodiments, each viewer comb filter 154 may be included in any suitable substrate (e.g., a glass panel) positioned between a viewer 140 and display surface 116.

In other embodiments, one or more subsets of projectors 112 do not project video streams 115 through projector comb filters 154. In these embodiments, the images projected by these subsets of projectors 112 are included in each subset 132 and seen by all viewers 140.

In FIG. 3B, channel selection device 130B includes vertical polarizers 162(1)-162(i) (collectively referred to as vertical polarizers 162), horizontal polarizers 164(1)-164(M-i) (collectively referred to as horizontal polarizers 164), at least one vertically polarized filter 166, and at least one horizontally polarized filter 168.

Vertical polarizers 162(1)-162(i) are configured to transmit only vertically polarized light from video streams 115(1)-115(i), respectively, and horizontal polarizers 164(1)-164(M-i) are configured to transmit only horizontally polarized light from video streams 115(i+1)-115(M), respectively.

Vertical polarizers 162 are used with one or more subsets of projectors 112 to project one or more vertically polarized images on display surface 116. Horizontal polarizers 164 are used with one or more other subsets of projectors 112 to project one or more horizontally polarized images on display surface 116.

Vertically polarized filter 166 and horizontally polarized filter 168 each receive the polarized images from display surface 116. Vertically polarized filter 166 filters the images from display surface 116 that are not vertically polarized to form a subset 132(1) that includes only vertically polarized images. Likewise, horizontally polarized filter 168 filters the images from display surface 116 that are not horizontally polarized to form a subset 132(2) that includes only horizontally polarized images. Another subset 132(3) is not filtered by either vertically polarized filter 166 or horizontally polarized filter 168 and includes the entire set of displayed images 114 including both vertically and horizontally polarized images.

Vertically polarized filter 166 and horizontally polarized filter 168 may be integrated with projectors 112 (e.g., inserted into the projection paths of projectors 112 or formed as part of specialized color wheels that transmit only the desired polarized light) or may be adjacent or otherwise external to projectors 112 in the projection path between projectors 112 and display surface 116.

In one embodiment, both vertically polarized filter 166 and horizontally polarized filter 168 may be included in a separate apparatus (not shown) for each viewer 140 where respective apparatus are positioned between respective viewers 140 and display surface 116. In this embodiment, a viewer 140 or other operator selects vertically polarized filter 166, horizontally polarized filter 168, or neither vertically polarized filter 166 nor horizontally polarized filter 168 for use at a given time to allow subset 132(1), 132(2), or 132(3), respectively, to be viewed by a viewer 140. In other embodiments, an apparatus with both vertically polarized filter 166 and horizontally polarized filter 168 may be formed for multiple viewers 140. In further embodiments, an apparatus with only one of vertically polarized filter 166 and horizontally polarized filter 168 may be formed for each viewer 140 or multiple viewers 140. In each the above embodiments, the apparatus may be glasses or a visor that fits on the face of a viewer 140 or any suitable substrate (e.g., a glass panel) positioned between a viewer 140 and display surface 116.

In other embodiments, one or more subsets of projectors 112 do not project video streams 115 through vertical polarizers 162 or horizontal polarizers 164. In these embodiments, the images projected by these subsets of projectors 112 are included in each subset 132 and seen by all viewers 140.

In other embodiments of channel selection device 130B, diagonal polarizers (not shown) may be used in place of or in addition to vertical polarizers 162 and horizontal polarizers 164 for one or more subsets of projectors 112, and diagonal polarized filters may be used in place of or in addition to vertically polarized filter 166 and horizontally polarized filter 168. For example, diagonal polarizers with a 45 degree polarization may be configured to transmit only 45 degree polarized light from video streams 115 and diagonal polarizers with a 135 degree polarization may be configured to transmit only 135 degree polarized light from video streams 115.

In these embodiments, any vertically polarized filters 166 filter the images from display surface 116 that are horiztonally polarized to form a subset 132 that includes the vertically and 45 and 135 degree diagonally polarized images. Likewise, any horizontally polarized filters 168 filter the images from display surface 116 that are vertically polarized to form a subset 132 that includes horizontally and 45 and 135 degree diagonally polarized images. Further, any 45 degree polarized filters filter the images from display surface 116 that are 135 degree polarized to form a subset 132 that includes vertically, horizontally, and 45 degree polarized images. Similarly, any 135 degree polarized filters filter the images from display surface 116 that are 45 degree polarized to form a subset 132 that includes vertically, horizontally, and 135 degree polarized images.

In further embodiments of channel selection device 130B, circular polarizers (not shown) may be used in place of or in addition to vertical polarizers 162 and horizontal polarizers 164 for one or more subsets of projectors 112, and circularly polarized filters may be used in place of or in addition to vertically polarized filter 166 and horizontally polarized filter 168. The circular polarizers may include clockwise circular polarizers and counterclockwise circular polarizers where clockwise circular polarizers polarize video streams 115 into clockwise polarizations and counterclockwise circular polarizers polarize video streams 115 into counterclockwise polarizations.

In these embodiments, clockwise circularly polarized filters filter the images from display surface 116 that are counterclockwise circularly polarized to form a subset 132 that includes the clockwise circularly polarized images. Similarly, counterclockwise circularly polarized filters filter the images from display surface 116 that are clockwise circularly polarized to form a subset 132 that includes the counterclockwise circularly polarized images.

In the above embodiments, vertical polarizers 162 and horizontal polarizers 164 form complementary polarizers that form complementary polarizations (i.e., vertical and horizontal polarizations). 45 degree diagonal polarizers and 135 degree diagonal polarizers also form complementary polarizers that form complementary polarizations (i.e., 45 degree diagonal and 135 degree polarizations). In addition, clockwise circular polarizers and counterclockwise circular polarizers form complementary polarizers that form complementary polarizations (i.e., clockwise circular polarizations and counterclockwise circular polarizations).

In the above embodiments, the polarizations of one or more subsets of projectors 112 may be time varying (e.g., by rotating or otherwise adjusting a polarizer). In addition, the polarizations filtered by a polarized filter may vary over time and may be synchronized with one or more subsets of projectors 112 with varying polarizations.

Display surface 116 may be configured to reflect or absorb selected polarizations of light in the above embodiments.

In FIG. 3C, channel selection device 130C includes pairs of shutter devices 172(1)-172(N) (collectively referred to as shutter devices 172). Each shutter device 172 is synchronized with one or more subsets of projectors 112 to allow viewers 140 to see different subsets 132. Two or more subsets of projectors 112 temporally interleave the projection of corresponding images on display surface 116. By doing so, each image appears on display surface 116 only during periodic time intervals and images for different channels appear during different time intervals. For example, if two subsets of projectors 112 each have a frame rate of 30 frames per second, then each subset may project a corresponding image onto display surface 116 at rate of 15 frames per second in alternating time intervals so that only one image appears on display surface 116 during each time interval.

Shutter devices 172 are synchronized with the periodic time intervals of one or more subsets of projectors 112. Although each shutter device 172 receives all images projected on display surface 116, each shutter device 172 transmits any images on display surface 116 to a respective viewer 140 only during selected time intervals. During other time intervals, each shutter device 172 blocks the transmission of all images on display surface 116. A shutter device 172 may also be operate to transmit during all time intervals to allow a viewer 140 to see the entire set of displayed images 114.

For example, a first subset of projectors 112 may project images during a first set of time intervals, and a second subset of projectors 112 may project images during a second set of time intervals that is mutually exclusive with the first set of time intervals (e.g., alternating). A shutter device 172(1) transmits the images on display surface 116 to viewer 140(1) during the first set of time intervals and blocks the transmission of images on display surface 116 during the second set of time intervals. Likewise, a shutter device 172(2) transmits the images on display surface 116 to viewer 140(2) during the second set of time intervals and blocks the transmission of images on display surface 116 during the first set of time intervals.

In one embodiment, shutter devices 172 include electronic shutters such as liquid crystal display (LCD) shutters. In other embodiments, shutter devices 172 include mechanical or other types of shutters.

In one embodiment, each shutter device 172 may be included in glasses or a visor that fits on the face of a viewer 140. In other embodiments, each shutter device 172 may be included in any suitable substrate (e.g., a glass panel) positioned between a viewer 140 and display surface 116.

In one embodiment, projectors 112 may be configured to operate with an increased frame rate (e.g., 60 frames per second) or the number of overlapping images on display surface 116 may be limited to minimize any flicker effects experienced by viewers 140.

In FIG. 3D, channel selection device 130D includes a lenticular array 178. Lenticular array 178 includes an array of lenses (not shown) where the lens are configured to direct video streams 115 from the subsets of projectors 112 in predefined directions to form subsets 132. The array of lenses is divided into any suitable number of subsets of lenses (not shown) where each subset directs portions of video streams 115 in different direction. Each subset of projectors 112 is configured to project a subset of sub-frames 110 onto a subset of lenses in lenticular array 178. Lenticular array 178 directs subsets of images in the set of displayed images so that viewers 140 can see one or more subsets of images and cannot see one or more subsets of images based on their relative to display surface 116. Accordingly, viewers 140 in different physical locations relative to display surface 116 see different subsets 132 as indicated by the different directions of the dashed arrows 132(1) and 132(N) in FIG. 3D.

Lenticular array 178 may be periodically configured to change or adjust the direction of display of one or more subsets 132. In addition, lenticular array 178 may be operated to transmit the entire set of displayed images 114 in a selected direction at various times.

Lenticular array 178 may be adjacent to display surface 116 (as shown in FIG. 3D), integrated with display surface 116, or positioned relative to display surface 116 in any other suitable configuration.

Each of the embodiments 130A-130D of channel selection device 130 may be preconfigured to allow a viewer to see a predetermined subset 132 or may be switchable to allow subsets 132 to be selected any time before or during viewing of display surface 116. Channel selection devices 130 may be switchable for individual viewers 140 by operating switches on components of channel selection device 130 to select a subset 132. The switches maybe operated directly on each component or may be operated remotely using any suitable wired or wireless connection. For example, viewer comb filters 140 (shown in FIG. 3A), devices with polarized filters (shown in FIG. 3B), shutter devices (shown in FIG. 3C), or lenticular arrays (shown in FIG. 3D) may be switched by a viewer 140 or a remote operator.

Referring back to FIG. 1, image display system 100 may also include an audio selection device (not shown) configured to selectively provide different audio streams associated with the different subsets 132 of displayed images 114 to different viewers 140.

Although described above as providing different subsets 132 to different viewers 140, channel selection device 130 may also provide different subsets 132 to each eye of each viewer 140 in other embodiments to allow viewers 140 to see 3D or stereoscopic images.

In one embodiment, sub-frame generator 108 generates image sub-frames 110 with a resolution that matches the resolution of projectors 112, which is less than the resolution of image frames 106 in one embodiment. Sub-frames 110 each include a plurality of columns and a plurality of rows of individual pixels representing a subset of an image frame 106.

In one embodiment, display system 100 is configured to give the appearance to the human eye of high-resolution displayed images 114 by displaying overlapping and spatially shifted lower-resolution sub-frames 110 from at least one subset of projectors 112. The projection of overlapping and spatially shifted sub-frames 110 may give the appearance of enhanced resolution (i.e., higher resolution than the sub-frames 110 themselves).

Sub-frames 110 projected onto display surface 116 may have perspective distortions, and the pixels may not appear as perfect squares with no variation in the offsets and overlaps from pixel to pixel, such as that shown in FIGS. 5A-5D. Rather, the pixels of sub-frames 110 may take the form of distorted quadrilaterals or some other shape, and the overlaps may vary as a function of position. Thus, terms such as “spatially shifted” and “spatially offset positions” as used herein are not limited to a particular pixel shape or fixed offsets and overlaps from pixel to pixel, but rather are intended to include any arbitrary pixel shape, and offsets and overlaps that may vary from pixel to pixel.

Image display system 100 includes hardware, software, firmware, or a combination of these. In one embodiment, one or more components of image display system 100 are included in a computer, computer server, or other microprocessor-based system capable of performing a sequence of logic operations. In addition, processing can be distributed throughout the system with individual portions being implemented in separate system components, such as in a networked or multiple computing unit environments.

Sub-frame generator 108 may be implemented in hardware, software, firmware, or any combination thereof. For example, sub-frame generator 108 may include a microprocessor, programmable logic device, or state machine. Sub-frame generator 108 may also include software stored on one or more computer-readable mediums and executable by a processing system (not shown). The term computer-readable medium as used herein is defined to include any kind of memory, volatile or non-volatile, such as floppy disks, hard disks, CD-ROMs, flash memory, read-only memory, and random access memory.

Image frame buffer 104 includes memory for storing image data 102 for the sets of image frames 106. Thus, image frame buffer 104 constitutes a database of image frames 106. Image frame buffers 113 also include memory for storing any number of sub-frames 110. Examples of image frame buffers 104 and 113 include non-volatile memory (e.g., a hard disk drive or other persistent storage device) and may include volatile memory (e.g., random access memory (RAM)).

Display surface 116 may be planar, non-planar, curved, or have any other suitable shape. In one embodiment, display surface 116 reflects the light projected by projectors 112 to form the set of displayed images 114. In another embodiment, display surface 116 is translucent, and display system 100 is configured as a rear projection system.

### II. Display of a Subset of Spatially Offset Sub-Frames by a Subset or Projectors

FIGS. 5A-5D are schematic diagrams illustrating the projection of four sub-frames 110(1), 110(2), 110(3), and 110(4) according to one exemplary embodiment. In this embodiment, display system 100 includes a subset of projectors 112 that includes four projectors 112, and sub-frame generator 108 generates at least a set of four sub-frames 110(1), 110(2), 110(3), and 110(4) for each of the image frames 106 corresponding to an image in the set of images 114 for display by the subset of projectors 112. As such, sub-frames 110(1), 110(2), 110(3), and 110(4) each include a plurality of columns and a plurality of rows of individual pixels 202 of image data.

FIG. 5A illustrates the display of sub-frame 110(1) by a first projector 112(1) on display surface 116. As illustrated in FIG. 5B, a second projector 112(2) simultaneously displays sub-frame 110(2) on display surface 116 offset from sub-frame 110(1) by a vertical distance 204 and a horizontal distance 206. As illustrated in FIG. 5C, a third projector 112(3) simultaneously displays sub-frame 110(3) on display surface 116 offset from sub-frame 110(1) by horizontal distance 206. A fourth projector 112(4) simultaneously displays sub-frame 110(4) on display surface 116 offset from sub-frame 110(1) by vertical distance 204 as illustrated in FIG. 5D.

Sub-frame 110(1) is spatially offset from first sub-frame 110(2) by a predetermined distance. Similarly, sub-frame 110(3) is spatially offset from first sub-frame 110(4) by a predetermined distance. In one illustrative embodiment, vertical distance 204 and horizontal distance 206 are each approximately one-half of one pixel.

The display of sub-frames 110(2), 110(3), and 110(4) are spatially shifted relative to the display of sub-frame 110(1) by vertical distance 204, horizontal distance 206, or a combination of vertical distance 204 and horizontal distance 206. As such, pixels 202 of sub-frames 110(1), 110(2), 110(3), and 110(4) at least partially overlap thereby producing the appearance of higher resolution pixels. Sub-frames 110(1), 110(2), 110(3), and 110(4) may be superimposed on one another (i.e., fully or substantially fully overlap), may be tiled (i.e., partially overlap at or near the edges), or may be a combination of superimposed and tiled. The overlapped sub-frames 110(1), 110(2), 110(3), and 110(4) also produce a brighter overall image than any of sub-frames 110(1), 110(2), 110(3), or 110(4) alone.

In other embodiments, other numbers of projectors 112 are used in system 100 and other numbers of sub-frames 110 are generated for each image frame 106.

In other embodiments, sub-frames 110(1), 110(2), 110(3), and 110(4) may be displayed at other spatial offsets relative to one another and the spatial offsets may vary over time.

In one embodiment, sub-frames 110 have a lower resolution than image frames 106. Thus, sub-frames 110 are also referred to herein as low-resolution images or sub-frames 110, and image frames 106 are also referred to herein as high-resolution images or frames 106. The terms low resolution and high resolution are used herein in a comparative fashion, and are not limited to any particular minimum or maximum number of pixels.

### III. Sub-Frame Generation

In one embodiment, sub-frame generator 108 determines appropriate values separately for each subset of sub-frames 110 where two or more sub-frames are used to form an image in the set of images 114 using the embodiments described with reference to FIGS. 6 and 7 below. In this embodiment, each subset of sub-frames 110 may be displayed at different times or in different spatially locations to allow camera 122 to capture images of one subset at a time, or camera 122 may include a channel selection component (not shown) configured to allow camera 122 to capture one or more selected subsets at a time.

In other embodiments where two or more sub-frames are used to form an image in the set of images 114, sub-frame generator 108 determines appropriate values for one or more subsets of sub-frames 110 using images from camera 122 that include two or more subsets of sub-frames 110 with the embodiments described with reference to FIGS. 6 and 7 below. In this embodiment, camera 122 may capture images with two or more selected subsets of sub-frames 110 at a time.

In one embodiment, display system 100 produces at least a partially superimposed projected output that takes advantage of natural pixel mis-registration to provide a displayed image with a higher resolution than the individual sub-frames 110. In one embodiment, image formation due to a subset of multiple overlapped projectors 112 is modeled using a signal processing model. Optimal sub-frames 110 for each of the component projectors 112 in the subset are estimated by sub-frame generator 108 based on the model, such that the resulting image predicted by the signal processing model is as close as possible to the desired high-resolution image to be projected. In one embodiment described with reference to FIG. 7, the signal processing model is used to derive values for sub-frames 110 that minimize visual color artifacts that can occur due to offset projection of single-color sub-frames 110.

In one embodiment, sub-frame generator 108 is configured to generate a subset of sub-frames 110 based on the maximization of a probability that, given a desired high resolution image, a simulated high-resolution image that is a function of the sub-frame values, is the same as the given, desired high-resolution image. If the generated subset of sub-frames 110 are optimal, the simulated high-resolution image will be as close as possible to the desired high-resolution image. The generation of optimal sub-frames 110 based on a simulated high-resolution image and a desired high-resolution image is described in further detail below with reference to the embodiment of FIG. 6 and the embodiment of FIG. 7.

A. Multiple Color Sub-Frames

FIG. 6 is a diagram illustrating a model of an image formation process that is separately performed by sub-frame generator 108 for each subset of projectors 112 with two or more projectors 112. Sub-frames 110 are represented in the model by Yₖ, where “k” is an index for identifying the individual projectors 112. Thus, Y₁, for example, corresponds to a sub-frame 110 for a first projector 112, Y₂ corresponds to a sub-frame 110 for a second projector 112, etc. Two of the sixteen pixels of the sub-frame 110 shown in FIG. 6 are highlighted, and identified by reference numbers 300A-1 and 300B-1. Sub-frames 110 (Yₖ) are represented on a hypothetical high-resolution grid by up-sampling (represented by D^{T}) to create up-sampled image 301. The up-sampled image 301 is filtered with an interpolating filter (represented by Hₖ) to create a high-resolution image 302 (Zₖ) with “chunky pixels”. This relationship is expressed in the following Equation I:

Zₖ=HₖD^{T}Yₖ Equation I
where:
   k=index for identifying the projectors 112;
   Zₖ=low-resolution sub-frame 110 of the kth projector 112 on a hypothetical high-resolution grid;
   Hₖ=Interpolating filter for low-resolution sub-frame 110 from kth projector 112;
   D^{T}=up-sampling matrix; and
   Yₖ=low-resolution sub-frame 110 of the kth projector 112.

The low-resolution sub-frame pixel data (Yₖ) is expanded with the up-sampling matrix (D^{T}) so that sub-frames 110 (Yₖ) can be represented on a high-resolution grid. The interpolating filter (Hₖ) fills in the missing pixel data produced by up-sampling. In the embodiment shown in FIG. 6, pixel 300A-1 from the original sub-frame 110 (Yₖ) corresponds to four pixels 300A-2 in the high-resolution image 302 (Zₖ), and pixel 300B-1 from the original sub-frame 110 (Yₖ) corresponds to four pixels 300B-2 in the high-resolution image 302 (Zₖ). The resulting image 302 (Zₖ) in Equation I models the output of the k^{th} projector 112 if there was no relative distortion or noise in the projection process. Relative geometric distortion between the projected component sub-frames 110 results due to the different optical paths and locations of the component projectors 112. A geometric transformation is modeled with the operator, Fₖ, which maps coordinates in the frame buffer 113 of the k^{th} projector 112 to frame buffer 120 of hypothetical reference projector 118 with sub-pixel accuracy, to generate a warped image 304 (Z_{ref}). In one embodiment, Fₖ is linear with respect to pixel intensities, but is non-linear with respect to the coordinate transformations. As shown in FIG. 6, the four pixels 300A-2 in image 302 are mapped to the three pixels 300A-3 in image 304, and the four pixels 300B-2 in image 302 are mapped to the four pixels 300B-3 in image 304.

In one embodiment, the geometric mapping (Fₖ) is a floating-point mapping, but the destinations in the mapping are on an integer grid in image 304. Thus, it is possible for multiple pixels in image 302 to be mapped to the same pixel location in image 304, resulting in missing pixels in image 304. To avoid this situation, in one embodiment, during the forward mapping (Fₖ), the inverse mapping (Fₖ⁻¹) is also utilized as indicated at 305 in FIG. 6. Each destination pixel in image 304 is back projected (i.e., Fₖ⁻¹) to find the corresponding location in image 302. For the embodiment shown in FIG. 6, the location in image 302 corresponding to the upper-left pixel of the pixels 300A-3 in image 304 is the location at the upper-left corner of the group of pixels 300A-2. In one embodiment, the values for the pixels neighboring the identified location in image 302 are combined (e.g., averaged) to form the value for the corresponding pixel in image 304. Thus, for the example shown in FIG. 6, the value for the upper-left pixel in the group of pixels 300A-3 in image 304 is determined by averaging the values for the four pixels within the frame 303 in image 302.

In another embodiment, the forward geometric mapping or warp (Fₖ) is implemented directly, and the inverse mapping (Fₖ⁻¹) is not used. In one form of this embodiment, a scatter operation is performed to eliminate missing pixels. That is, when a pixel in image 302 is mapped to a floating point location in image 304, some of the image data for the pixel is essentially scattered to multiple pixels neighboring the floating point location in image 304. Thus, each pixel in image 304 may receive contributions from multiple pixels in image 302, and each pixel in image 304 is normalized based on the number of contributions it receives.

A superposition/summation of such warped images 304 from all of the component projectors 112 forms a hypothetical or simulated high-resolution image 306 (\hat{X}, also referred to as X-hat herein) in reference projector frame buffer 120, as represented in the following Equation II:

$$\hat{X} = {\sum }_{k} {F}_{k} {Z}_{k} \qquad Equation II$$

where:
   k=index for identifying the projectors 112;
   X-hat=hypothetical or simulated high-resolution image 306 in the reference projector frame buffer 120;
   Fₖ=operator that maps a low-resolution sub-frame 110 of the kth projector 112 on a hypothetical high-resolution grid to the reference projector frame buffer 120; and
   Zₖ=low-resolution sub-frame 110 of kth projector 112 on a hypothetical high-resolution grid, as defined in Equation I.

If the simulated high-resolution image 306 (X-hat) in reference projector frame buffer 120 is identical to a given (desired) high-resolution image 308 (X), the system of component low-resolution projectors 112 would be equivalent to a hypothetical high-resolution projector placed at the same location as hypothetical reference projector 118 and sharing its optical path. In one embodiment, the desired high-resolution images 308 are the high-resolution image frames 106 received by sub-frame generator 108.

In one embodiment, the deviation of the simulated high-resolution image 306 (X-hat) from the desired high-resolution image 308 (X) is modeled as shown in the following Equation III:

X=\hat{X}+η Equation III
where:
   X=desired high-resolution frame 308;
   X-hat=hypothetical or simulated high-resolution frame 306 in reference projector frame buffer 120; and
   η=error or noise term.

As shown in Equation III, the desired high-resolution image 308 (X) is defined as the simulated high-resolution image 306 (X-hat) plus η, which in one embodiment represents zero mean white Gaussian noise.

The solution for the optimal sub-frame data (Yₖ*) for sub-frames 110 is formulated as the optimization given in the following Equation IV:

$${Y}_{k}^{*} = {argmax}_{{Y}_{k}} P ( \hat{X} \vert X ) \qquad Equation IV$$

where:
   k=index for identifying the projectors 112;
   Yₖ*=optimum low-resolution sub-frame 110 of the kth projector 112;
   Yₖ=low-resolution sub-frame 110 of the kth projector 112;
   X-hat=hypothetical or simulated high-resolution frame 306 in reference projector frame buffer 120, as defined in Equation II;
   X=desired high-resolution frame 308; and
   P(X-hat|X)=probability of X-hat given X.

Thus, as indicated by Equation IV, the goal of the optimization is to determine the sub-frame values (Yₖ) that maximize the probability of X-hat given X. Given a desired high-resolution image 308 (X) to be projected, sub-frame generator 108 determines the component sub-frames 110 that maximize the probability that the simulated high-resolution image 306 (X-hat) is the same as or matches the “true” high-resolution image 308 (X).

Using Bayes rule, the probability P(X-hat|X) in Equation IV can be written as shown in the following Equation V:

$$P ( \hat{X} \vert X ) = \frac{P ( X \vert \hat{X} ) P ( \hat{X} )}{P ( X )} \qquad Equation V$$

where:
   X-hat=hypothetical or simulated high-resolution frame 306 in reference projector frame buffer 120, as defined in Equation II;
   X=desired high-resolution frame 308;
   P(X-hat|X)=probability of X-hat given X;
   P(X|X-hat)=probability of X given X-hat;
   P(X-hat)=prior probability of X-hat; and
   P(X)=prior probability of X.

The term P(X) in Equation V is a known constant. If X-hat is given, then, referring to Equation III, X depends only on the noise term, η, which is Gaussian. Thus, the term P(X|X-hat) in Equation V will have a Gaussian form as shown in the following Equation VI:

$$P ( X \vert \hat{X} ) = \frac{1}{C} {e}^{- \frac{‖ X - \hat{X} ‖}{2 {σ}^{2}}} \qquad Equation VI$$

where:
   X-hat=hypothetical or simulated high-resolution frame 306 in reference projector frame buffer 120, as defined in Equation II;
   X=desired high-resolution frame 308;
   P(X|X-hat)=probability of X given X-hat;
   C=normalization constant; and
   σ=variance of the noise term, η.

To provide a solution that is robust to minor calibration errors and noise, a “smoothness” requirement is imposed on X-hat. In other words, it is assumed that good simulated images 306 have certain properties. The smoothness requirement according to one embodiment is expressed in terms of a desired Gaussian prior probability distribution for X-hat given by the following Equation VII:

$$P ( \hat{X} ) = \frac{1}{Z ( β )} {e}^{- \{ {β}^{2} ( {‖ ∇ \hat{X} ‖}^{2} ) \}} \qquad Equation VII$$

where:
   P(X-hat)=prior probability of X-hat;
   β=smoothing constant;
   Z(β)=normalization function;
   ∇=gradient operator; and
   X-hat=hypothetical or simulated high-resolution frame 306 in reference projector frame buffer 120, as defined in Equation II.

In another embodiment, the smoothness requirement is based on a prior Laplacian model, and is expressed in terms of a probability distribution for X-hat given by the following Equation VIII:

$$P ( \hat{X} ) = \frac{1}{Z ( β )} {e}^{- \{ β ( ‖ ∇ \hat{X} ‖ ) \}} \qquad Equation VIII$$

where:
   P(X-hat)=prior probability of X-hat;
   β=smoothing constant;
   Z(β)=normalization function;
   ∇=gradient operator; and
   X-hat=hypothetical or simulated high-resolution frame 306 in reference projector frame buffer 120, as defined in Equation II.

The following discussion assumes that the probability distribution given in Equation VII, rather than Equation VIII, is being used. As will be understood by persons of ordinary skill in the art, a similar procedure would be followed if Equation VIII were used. Inserting the probability distributions from Equations VI and VII into Equation V, and inserting the result into Equation IV, results in a maximization problem involving the product of two probability distributions (note that the probability P(X) is a known constant and goes away in the calculation). By taking the negative logarithm, the exponents go away, the product of the two probability distributions becomes a sum of two probability distributions, and the maximization problem given in Equation IV is transformed into a function minimization problem, as shown in the following Equation IX:

$${Y}_{k}^{*} = {argmin}_{{Y}_{k}} {‖ X - \hat{X} ‖}^{2} + {β}^{2} {‖ ∇ \hat{X} ‖}^{2} \qquad Equation IX$$

where:
   k=index for identifying the projectors 112;
   Yₖ*=optimum low-resolution sub-frame 110 of the kth projector 112;
   Yₖ=low-resolution sub-frame 110 of the kth projector 112;
   X-hat=hypothetical or simulated high-resolution frame 306 in reference projector frame buffer 120, as defined in Equation II;
   X=desired high-resolution frame 308;
   β=smoothing constant; and
   ∇=gradient operator.

The function minimization problem given in Equation IX is solved by substituting the definition of X-hat from Equation II into Equation IX and taking the derivative with respect to Yₖ, which results in an iterative algorithm given by the following Equation X:

Yₖ⁽ⁿ⁺¹⁾=Yₖ⁽ⁿ⁾−Θ{DHₖ^{T}Fₖ^{T}└(\hat{X}⁽ⁿ⁾−X)+β²∇²\hat{X}⁽ⁿ⁾┘} Equation X
where:
   k=index for identifying the projectors 112;
   n=index for identifying iterations;
   Yₖ⁽ⁿ⁺¹⁾=low-resolution sub-frame 110 for the kth projector 112 for iteration number n+1;
   Yₖ⁽ⁿ⁾=low-resolution sub-frame 110 for the kth projector 112 for iteration number n;
   Θ=momentum parameter indicating the fraction of error to be incorporated at each iteration;
   D=down-sampling matrix;
   Hₖ^{T}=Transpose of interpolating filter, Hₖ, from Equation I (in the image domain, Hₖ^{T} is a flipped version of Hₖ);
   Fₖ^{T}=Transpose of operator, Fₖ, from Equation II (in the image domain, Fₖ^{T} is the inverse of the warp denoted by Fₖ);
   X-hat⁽ⁿ⁾=hypothetical or simulated high-resolution frame 306 in the reference projector frame buffer, as defined in Equation II, for iteration number n;
   X=desired high-resolution frame 308;
   β=smoothing constant; and
   ∇²=Laplacian operator.

Equation X may be intuitively understood as an iterative process of computing an error in the hypothetical reference projector coordinate system and projecting it back onto the sub-frame data. In one embodiment, sub-frame generator 108 is configured to generate sub-frames 110 in real-time using Equation X. The generated sub-frames 110 are optimal in one embodiment because they maximize the probability that the simulated high-resolution image 306 (X-hat) is the same as the desired high-resolution image 308 (X), and they minimize the error between the simulated high-resolution image 306 and the desired high-resolution image 308. Equation X can be implemented very efficiently with conventional image processing operations (e.g., transformations, down-sampling, and filtering). The iterative algorithm given by Equation X converges rapidly in a few iterations and is very efficient in terms of memory and computation (e.g., a single iteration uses two rows in memory; and multiple iterations may also be rolled into a single step). The iterative algorithm given by Equation X is suitable for real-time implementation, and may be used to generate optimal sub-frames 110 at video rates, for example.

To begin the iterative algorithm defined in Equation X, an initial guess, Yₖ⁽⁰⁾, for sub-frames 110 is determined. In one embodiment, the initial guess for sub-frames 110 is determined by texture mapping the desired high-resolution frame 308 onto sub-frames 110. In one embodiment, the initial guess is determined from the following Equation XI:

Yₖ⁽⁰⁾=DBₖFₖ^{T}X Equation XI
where:
   k=index for identifying the projectors 112;
   Yₖ⁽⁰⁾=initial guess at the sub-frame data for the sub-frame 110 for the kth projector 112;
   D=down-sampling matrix;
   Bₖ=interpolation filter;
   Fₖ^{T}=Transpose of operator, Fₖ, from Equation II (in the image domain, Fₖ^{T} is the inverse of the warp denoted by Fₖ); and
   X=desired high-resolution frame 308.

Thus, as indicated by Equation XI, the initial guess (Yₖ⁽⁰⁾) is determined by performing a geometric transformation (Fₖ^{T}) on the desired high-resolution frame 308 (X), and filtering (Bₖ) and down-sampling (D) the result. The particular combination of neighboring pixels from the desired high-resolution frame 308 that are used in generating the initial guess (Yₖ⁽⁰⁾) will depend on the selected filter kernel for the interpolation filter (Bₖ).

In another embodiment, the initial guess, Yₖ⁽⁰⁾, for sub-frames 110 is determined from the following Equation XII

Yₖ⁽⁰⁾=DFₖ^{T}X Equation XII
where:
   k=index for identifying the projectors 112;
   Yₖ⁽⁰⁾=initial guess at the sub-frame data for the sub-frame 110 for the kth projector 112;
   D=down-sampling matrix;
   Fₖ^{T}=Transpose of operator, Fₖ, from Equation II (in the image domain, Fₖ^{T} is the inverse of the warp denoted by Fₖ); and
   X=desired high-resolution frame 308.

Equation XII is the same as Equation XI, except that the interpolation filter (Bₖ) is not used.

Several techniques are available to determine the geometric mapping (Fₖ) between each projector 112 and hypothetical reference projector 118, including manually establishing the mappings, or using camera 122 and calibration unit 124 to automatically determine the mappings. In one embodiment, if camera 122 and calibration unit 124 are used, the geometric mappings between each projector 112 and camera 122 are determined by calibration unit 124. These projector-to-camera mappings may be denoted by Tₖ, where k is an index for identifying projectors 112. Based on the projector-to-camera mappings (Tₖ), the geometric mappings (Fₖ) between each projector 112 and hypothetical reference projector 118 are determined by calibration unit 124, and provided to sub-frame generator 108. For example, in a display system 100 with two projectors 112(1) and 112(2), assuming the first projector 112(1) is hypothetical reference projector 118, the geometric mapping of the second projector 112(2) to the first (reference) projector 112(1) can be determined as shown in the following Equation XIII:

F₂=T₂T₁⁻¹ Equation XIII
where:
   F₂=operator that maps a low-resolution sub-frame 110 of the second projection device 112(2) to the first (reference) projector 112(1);
   T₁=geometric mapping between the first projector 112(1) and camera 122; and
   T₂=geometric mapping between the second projector 112(2) and camera 122.

In one embodiment, the geometric mappings (Fₖ) are determined once by calibration unit 124, and provided to sub-frame generator 108. In another embodiment, calibration unit 124 continually determines (e.g., once per frame 106) the geometric mappings (Fₖ), and continually provides updated values for the mappings to sub-frame generator 108.

B. Single Color Sub-Frames

In another embodiment illustrated by the embodiment of FIG. 7, sub-frame generator 108 determines and generates single-color sub-frames 110 for each projector 112 in a subset of projectors 112 that minimize color aliasing due to offset projection. This process may be thought of as inverse de-mosaicking. A de-mosaicking process seeks to synthesize a high-resolution, full color image free of color aliasing given color samples taken at relative offsets. In one embodiment, sub-frame generator 108 essentially performs the inverse of this process and determines the colorant values to be projected at relative offsets, given a full color high-resolution image 106. The generation of optimal subsets of sub-frames 110 based on a simulated high-resolution image and a desired high-resolution image is described in further detail below with reference to FIG. 7.

FIG. 7 is a diagram illustrating a model of an image formation process separately performed by sub-frame generator 108 for each set of projectors 112. Sub-frames 110 are represented in the model by Yᵢₖ, where “k” is an index for identifying individual sub-frames 110, and “i” is an index for identifying color planes. Two of the sixteen pixels of the sub-frame 110 shown in FIG. 7 are highlighted, and identified by reference numbers 400A-1 and 400B-1. Sub-frames 110 (Yᵢₖ) are represented on a hypothetical high-resolution grid by up-sampling (represented by Dᵢ^{T}) to create up-sampled image 401. The up-sampled image 401 is filtered with an interpolating filter (represented by Hᵢ) to create a high-resolution image 402 (Zᵢₖ) with “chunky pixels”. This relationship is expressed in the following Equation XIV:

Zᵢₖ=HᵢDᵢ^{T}Yᵢₖ Equation XIV
where:
   k=index for identifying individual sub-frames 110;
   i=index for identifying color planes;
   Zᵢₖ=kth low-resolution sub-frame 110 in the ith color plane on a hypothetical high-resolution grid;
   Hᵢ=Interpolating filter for low-resolution sub-frames 110 in the ith color plane;
   Dᵢ^{T}=up-sampling matrix for sub-frames 110 in the ith color plane; and
   Yᵢₖ=kth low-resolution sub-frame 110 in the ith color plane.

The low-resolution sub-frame pixel data (Yᵢₖ) is expanded with the up-sampling matrix (Dᵢ^{T}) so that sub-frames 110 (Yᵢₖ) can be represented on a high-resolution grid. The interpolating filter (Hᵢ) fills in the missing pixel data produced by up-sampling. In the embodiment shown in FIG. 7, pixel 400A-1 from the original sub-frame 110 (Yᵢₖ) corresponds to four pixels 400A-2 in the high-resolution image 402 (Zᵢₖ), and pixel 400B-1 from the original sub-frame 110 (Yᵢₖ) corresponds to four pixels 400B-2 in the high-resolution image 402 (Zᵢₖ). The resulting image 402 (Zᵢₖ) in Equation XIV models the output of the projectors 112 if there was no relative distortion or noise in the projection process. Relative geometric distortion between the projected component sub-frames 110 results due to the different optical paths and locations of the component projectors 112. A geometric transformation is modeled with the operator, Fᵢₖ, which maps coordinates in the frame buffer 113 of a projector 112 to frame buffer 120 of hypothetical reference projector 118 with sub-pixel accuracy, to generate a warped image 404 (Z_{ref}). In one embodiment, Fᵢₖ is linear with respect to pixel intensities, but is non-linear with respect to the coordinate transformations. As shown in FIG. 7, the four pixels 400A-2 in image 402 are mapped to the three pixels 400A-3 in image 404, and the four pixels 400B-2 in image 402 are mapped to the four pixels 400B-3 in image 404.

In one embodiment, the geometric mapping (Fᵢₖ) is a floating-point mapping, but the destinations in the mapping are on an integer grid in image 404. Thus, it is possible for multiple pixels in image 402 to be mapped to the same pixel location in image 404, resulting in missing pixels in image 404. To avoid this situation, in one embodiment, during the forward mapping (Fᵢₖ), the inverse mapping (Fᵢₖ⁻¹) is also utilized as indicated at 405 in FIG. 7. Each destination pixel in image 404 is back projected (i.e., Fᵢₖ⁻¹) to find the corresponding location in image 402. For the embodiment shown in FIG. 7, the location in image 402 corresponding to the upper-left pixel of the pixels 400A-3 in image 404 is the location at the upper-left corner of the group of pixels 400A-2. In one embodiment, the values for the pixels neighboring the identified location in image 402 are combined (e.g., averaged) to form the value for the corresponding pixel in image 404. Thus, for the example shown in FIG. 7, the value for the upper-left pixel in the group of pixels 400A-3 in image 404 is determined by averaging the values for the four pixels within the frame 403 in image 402.

In another embodiment, the forward geometric mapping or warp (Fₖ) is implemented directly, and the inverse mapping (Fₖ⁻¹) is not used. In one form of this embodiment, a scatter operation is performed to eliminate missing pixels. That is, when a pixel in image 402 is mapped to a floating point location in image 404, some of the image data for the pixel is essentially scattered to multiple pixels neighboring the floating point location in image 404. Thus, each pixel in image 404 may receive contributions from multiple pixels in image 402, and each pixel in image 404 is normalized based on the number of contributions it receives.

A superposition/summation of such warped images 404 from all of the component projectors 112 in a given color plane forms a hypothetical or simulated high-resolution image (X-hatᵢ) for that color plane in reference projector frame buffer 120, as represented in the following Equation XV:

$${\hat{X}}_{i} = {\sum }_{k} {F}_{ik} {Z}_{ik} \qquad Equation XV$$

where:
   k=index for identifying individual sub-frames 110;
   i=index for identifying color planes;
   X-hatᵢ=hypothetical or simulated high-resolution image for the ith color plane in the reference projector frame buffer 120;
   Fᵢₖ=operator that maps the kth low-resolution sub-frame 110 in the ith color plane on a hypothetical high-resolution grid to the reference projector frame buffer 120; and
   Zᵢₖ=kth low-resolution sub-frame 110 in the ith color plane on a hypothetical high-resolution grid, as defined in Equation XIV.

A hypothetical or simulated image 406 (X-hat) is represented by the following Equation XVI:

\hat{X}=[\hat{X}₁ \hat{X}₂ . . . \hat{X}_{N}]^{T} Equation XVI
where:
   X-hat=hypothetical or simulated high-resolution image in reference projector frame buffer 120;
   X-hat₁=hypothetical or simulated high-resolution image for the first color plane in reference projector frame buffer 120, as defined in Equation XV;
   X-hat₂=hypothetical or simulated high-resolution image for the second color plane in reference projector frame buffer 120, as defined in Equation XV;
   X-hat_{N}=hypothetical or simulated high-resolution image for the Nth color plane in reference projector frame buffer 120, as defined in Equation XV; and
   N=number of color planes.

If the simulated high-resolution image 406 (X-hat) in reference projector frame buffer 120 is identical to a given (desired) high-resolution image 408 (X), the system of component low-resolution projectors 112 would be equivalent to a hypothetical high-resolution projector placed at the same location as hypothetical reference projector 118 and sharing its optical path. In one embodiment, the desired high-resolution images 408 are the high-resolution image frames 106 received by sub-frame generator 108.

In one embodiment, the deviation of the simulated high-resolution image 406 (X-hat) from the desired high-resolution image 408 (X) is modeled as shown in the following Equation XVII:

X=\hat{X}+η Equation XVII
where:
   X=desired high-resolution frame 408;
   X-hat=hypothetical or simulated high-resolution frame 406 in reference projector frame buffer 120; and
   η=error or noise term.

As shown in Equation XVII, the desired high-resolution image 408 (X) is defined as the simulated high-resolution image 406 (X-hat) plus η, which in one embodiment represents zero mean white Gaussian noise.

The solution for the optimal sub-frame data (Yᵢₖ*) for sub-frames 110 is formulated as the optimization given in the following Equation XVIII:

$${Y}_{ik}^{*} = {argmax}_{{Y}_{ik}} P ( \hat{X} \vert X ) \qquad Equation XVIII$$

where:
   k=index for identifying individual sub-frames 110;
   i=index for identifying color planes;
   Yᵢₖ*=optimum low-resolution sub-frame data for the kth sub-frame 110 in the ith color plane;
   Yᵢₖ=kth low-resolution sub-frame 110 in the ith color plane;
   X-hat=hypothetical or simulated high-resolution frame 406 in reference projector frame buffer 120, as defined in Equation XVI;
   X=desired high-resolution frame 408; and
   P(X-hat|X)=probability of X-hat given X.

Thus, as indicated by Equation XVIII, the goal of the optimization is to determine the sub-frame values (Yᵢₖ) that maximize the probability of X-hat given X. Given a desired high-resolution image 408 (X) to be projected, sub-frame generator 108 determines the component sub-frames 110 that maximize the probability that the simulated high-resolution image 406 (X-hat) is the same as or matches the “true” high-resolution image 408 (X).

Using Bayes rule, the probability P(X-hat|X) in Equation XVIII can be written as shown in the following Equation XIX:

$$P ( \hat{X} \vert X ) = \frac{P ( X \vert \hat{X} ) P ( \hat{X} )}{P ( X )} \qquad Equation XIX$$

where:
   X-hat=hypothetical or simulated high-resolution frame 406 in reference projector frame buffer 120, as defined in Equation XVI;
   X=desired high-resolution frame 408;
   P(X-hat|X)=probability of X-hat given X;
   P(X|X-hat)=probability of X given X-hat;
   P(X-hat)=prior probability of X-hat; and
   P(X)=prior probability of X.

The term P(X) in Equation XIX is a known constant. If X-hat is given, then, referring to Equation XVII, X depends only on the noise term, η, which is Gaussian. Thus, the term P(X|X-hat) in Equation XIX will have a Gaussian form as shown in the following Equation XX:

$$P ( X \vert \hat{X} ) = \frac{1}{C} {e}^{- {\sum }_{i} \frac{( {‖ {X}_{i} - {\hat{X}}_{i} ‖}^{2} )}{2 {σ}_{i}^{2}}} \qquad Equation XX$$

where:
   X-hat=hypothetical or simulated high-resolution frame 406 in reference projector frame buffer 120, as defined in Equation XVI;
   X=desired high-resolution frame 408;
   P(X|X-hat)=probability of X given X-hat;
   C=normalization constant;
   i=index for identifying color planes;
   Xᵢ=ith color plane of the desired high-resolution frame 408;
   X-hatᵢ=hypothetical or simulated high-resolution image for the ith color plane in the reference projector frame buffer 120, as defined in Equation XV; and
   σᵢ=variance of the noise term, η, for the ith color plane.

To provide a solution that is robust to minor calibration errors and noise, a “smoothness” requirement is imposed on X-hat. In other words, it is assumed that good simulated images 406 have certain properties. For example, for most good color images, the luminance and chrominance derivatives are related by a certain value. In one embodiment, a smoothness requirement is imposed on the luminance and chrominance of the X-hat image based on a “Hel-Or” color prior model, which is a conventional color model known to those of ordinary skill in the art. The smoothness requirement according to one embodiment is expressed in terms of a desired probability distribution for X-hat given by the following Equation XXI:

$$P ( \hat{X} ) = \frac{1}{Z ( α , β )} {e}^{- \{ {α}^{2} ( {‖ ∇ {\hat{C}}_{1} ‖}^{2} + {‖ ∇ {\hat{C}}_{2} ‖}^{2} ) + {β}^{2} ( {‖ ∇ \hat{L} ‖}^{2} ) \}} \qquad Equation XXI$$

where:
   P(X-hat)=prior probability of X-hat;
   α and β=smoothing constants;
   Z(α, β)=normalization function;
   ∇=gradient operator; and
   C-hat₁=first chrominance channel of X-hat;
   C-hat₂=second chrominance channel of X-hat; and
   L-hat=luminance of X-hat.

In another embodiment, the smoothness requirement is based on a prior Laplacian model, and is expressed in terms of a probability distribution for X-hat given by the following Equation XXII:

$$P ( \hat{X} ) = \frac{1}{Z ( α , β )} {e}^{- \{ α ( \vert ∇ {\hat{C}}_{1} \vert + \vert ∇ {\hat{C}}_{2} \vert ) + β ( \vert ∇ \hat{L} \vert ) \}} \qquad Equation XXII$$

where:
   P(X-hat)=prior probability of X-hat;
   α and β=smoothing constants;
   Z(α, β)=normalization function;
   ∇=gradient operator; and
   C-hat₁=first chrominance channel of X-hat;
   C-hat₂=second chrominance channel of X-hat; and
   L-hat=luminance of X-hat.

The following discussion assumes that the probability distribution given in Equation XXI, rather than Equation XXII, is being used. As will be understood by persons of ordinary skill in the art, a similar procedure would be followed if Equation XXII were used. Inserting the probability distributions from Equations XX and XXI into Equation XIX, and inserting the result into Equation XVIII, results in a maximization problem involving the product of two probability distributions (note that the probability P(X) is a known constant and goes away in the calculation). By taking the negative logarithm, the exponents go away, the product of the two probability distributions becomes a sum of two probability distributions, and the maximization problem given in Equation V is transformed into a function minimization problem, as shown in the following Equation XXIII:

$$\begin{matrix}{Y}_{ik}^{*} = {argmin}_{{Y}_{ik}} {\sum }_{i = 1}^{N} {‖ {X}_{i} - {\hat{X}}_{i} ‖}^{2} + {α}^{2} \{ {‖ ∇ ( {\sum }_{i = 1}^{N} {T}_{{C}_{1} i} \hat{X} ) ‖}^{2} + {‖ ∇ ( {\sum }_{i = 1}^{N} {T}_{{C}_{2} i} {\hat{X}}_{i} ) ‖}^{2} \} + {β}^{2} {‖ ∇ ( {\sum }_{i = 1}^{N} {T}_{Li} \hat{X} ) ‖}^{2} & Equation XXIII\end{matrix}$$

where:
   k=index for identifying individual sub-frames 110;
   i=index for identifying color planes;
   Yᵢₖ*=optimum low-resolution sub-frame data for the kth sub-frame 110 in the ith color plane;
   Yᵢₖ=kth low-resolution sub-frame 110 in the ith color plane;
   N=number of color planes;
   Xᵢ=ith color plane of the desired high-resolution frame 408;
   X-hatᵢ=hypothetical or simulated high-resolution image for the ith color plane in the reference projector frame buffer 120, as defined in Equation XV;
   α and β=smoothing constants;
   ∇=gradient operator;
   T_{C1i}=ith element in the second row in a color transformation matrix, T, for transforming the first chrominance channel of X-hat;
   T_{C2i}=ith element in the third row in a color transformation matrix, T, for transforming the second chrominance channel of X-hat; and

T_{Li}=ith element in the first row in a color transformation matrix, T, for transforming the luminance of X-hat.

The function minimization problem given in Equation XXIII is solved by substituting the definition of X-hatᵢ from Equation XV into Equation XXIII and taking the derivative with respect to Yᵢₖ, which results in an iterative algorithm given by the following Equation XXIV:

$${Y}_{ik}^{( n + 1 )} = {Y}_{ik}^{( n )} - Θ \{ {D}_{i} {F}_{ik}^{T} {H}_{i}^{T} [ ( {\hat{X}}_{i}^{( n )} - {X}_{i} ) + {α}^{2} {∇}^{2} ( {T}_{{C}_{1} i} {\sum }_{j = 1}^{N} {T}_{{C}_{1} j} {\hat{X}}_{j}^{( n )} + {T}_{{C}_{2} i} {\sum }_{j = 1}^{N} {T}_{{C}_{2} j} {\hat{X}}_{j}^{( n )} ) ⋯ + {β}^{2} {∇}^{2} {T}_{Li} {\sum }_{j = 1}^{N} {T}_{Lj} {\hat{X}}_{j}^{( n )} ] \} \qquad Equation XXIV$$

where:
   k=index for identifying individual sub-frames 110;
   i and j=indices for identifying color planes;
   n=index for identifying iterations;
   Yᵢₖ⁽ⁿ⁺¹⁾=kth low-resolution sub-frame 110 in the ith color plane for iteration number n+1;
   Yᵢₖ⁽ⁿ⁾=kth low-resolution sub-frame 110 in the ith color plane for iteration number n;
   Θ=momentum parameter indicating the fraction of error to be incorporated at each iteration;
   Dᵢ=down-sampling matrix for the ith color plane;
   Hᵢ^{T}=Transpose of interpolating filter, Hᵢ, from Equation XIV (in the image domain, Hᵢ^{T} is a flipped version of Hᵢ);
   Fᵢₖ^{T}=Transpose of operator, Fᵢₖ, from Equation XV (in the image domain, Fᵢₖ^{T} is the inverse of the warp denoted by Fᵢₖ);
   X-hatᵢ⁽ⁿ⁾=hypothetical or simulated high-resolution image for the ith color plane in the reference projector frame buffer 120, as defined in Equation XV, for iteration number n;
   Xᵢ=ith color plane of the desired high-resolution frame 408;
   α and β=smoothing constants;
   ∇²=Laplacian operator;
   T_{C1i}=ith element in the second row in a color transformation matrix, T, for transforming the first chrominance channel of X-hat;
   T_{C2i}=ith element in the third row in a color transformation matrix, T, for transforming the second chrominance channel of X-hat;
   T_{Li}=ith element in the first row in a color transformation matrix, T, for transforming the luminance of X-hat;
   X-hatⱼ⁽ⁿ⁾=hypothetical or simulated high-resolution image for the jth color plane in the reference projector frame buffer 120, as defined in Equation XV, for iteration number n;
   T_{C1j}=jth element in the second row in a color transformation matrix, T, for transforming the first chrominance channel of X-hat;
   T_{C2j}=jth element in the third row in a color transformation matrix, T, for transforming the second chrominance channel of X-hat;
   T_{Lj}=jth element in the first row in a color transformation matrix, T, for transforming the luminance of X-hat; and
   N=number of color planes.

Equation XXIV may be intuitively understood as an iterative process of computing an error in the hypothetical reference projector coordinate system and projecting it back onto the sub-frame data. In one embodiment, sub-frame generator 108 is configured to generate sub-frames 110 in real-time using Equation XXIV. The generated sub-frames 110 are optimal in one embodiment because they maximize the probability that the simulated high-resolution image 406 (X-hat) is the same as the desired high-resolution image 408 (X), and they minimize the error between the simulated high-resolution image 406 and the desired high-resolution image 408. Equation XXIV can be implemented very efficiently with conventional image processing operations (e.g., transformations, down-sampling, and filtering). The iterative algorithm given by Equation XXIV converges rapidly in a few iterations and is very efficient in terms of memory and computation (e.g., a single iteration uses two rows in memory; and multiple iterations may also be rolled into a single step). The iterative algorithm given by Equation XXIV is suitable for real-time implementation, and may be used to generate optimal sub-frames 110 at video rates, for example.

To begin the iterative algorithm defined in Equation XXIV, an initial guess, Yᵢₖ⁽⁰⁾, for sub-frames 110 is determined. In one embodiment, the initial guess for sub-frames 110 is determined by texture mapping the desired high-resolution frame 408 onto sub-frames 110. In one embodiment, the initial guess is determined from the following Equation XXV:

Yᵢₖ⁽⁰⁾=DᵢBᵢFᵢₖ^{T}Xᵢ Equation XXV
where:
   k=index for identifying individual sub-frames 110;
   i=index for identifying color planes;
   Yᵢₖ⁽⁰⁾=initial guess at the sub-frame data for the kth sub-frame 110 for the ith color plane;
   Dᵢ=down-sampling matrix for the ith color plane;
   Bᵢ=interpolation filter for the ith color plane;
   Fᵢₖ^{T}=Transpose of operator, Fᵢₖ, from Equation II (in the image domain, Fᵢₖ^{T} is the inverse of the warp denoted by Fᵢₖ); and
   Xᵢ=ith color plane of the desired high-resolution frame 408.

Thus, as indicated by Equation XXV, the initial guess (Yᵢₖ⁽⁰⁾) is determined by performing a geometric transformation (Fᵢₖ^{T}) on the ith color plane of the desired high-resolution frame 408 (Xᵢ), and filtering (Bᵢ) and down-sampling (Dᵢ) the result. The particular combination of neighboring pixels from the desired high-resolution frame 408 that are used in generating the initial guess (Yᵢₖ⁽⁰⁾) will depend on the selected filter kernel for the interpolation filter (Bᵢ).

In another embodiment, the initial guess, Yᵢₖ⁽⁰⁾, for sub-frames 110 is determined from the following Equation XXVI:

Yᵢₖ⁽⁰⁾=DᵢFᵢₖ^{T}Xᵢ Equation XXVI
where:
   k=index for identifying individual sub-frames 110;
   i=index for identifying color planes;
   Yᵢₖ⁽⁰⁾=initial guess at the sub-frame data for the kth sub-frame 110 for the ith color plane;
   Dᵢ=down-sampling matrix for the ith color plane;
   Fᵢₖ^{T}=Transpose of operator, Fᵢₖ, from Equation II (in the image domain, Fᵢₖ^{T} is the inverse of the warp denoted by Fᵢₖ); and
   Xᵢ=ith color plane of the desired high-resolution frame 408.

Equation XXVI is the same as Equation XXV, except that the interpolation filter (Bₖ) is not used.

Several techniques are available to determine the geometric mapping (Fᵢₖ) between each projector 112 and hypothetical reference projector 118, including manually establishing the mappings, or using camera 122 and calibration unit 124 to automatically determine the mappings. In one embodiment, if camera 122 and calibration unit 124 are used, the geometric mappings between each projector 112 and camera 122 are determined by calibration unit 124. These projector-to-camera mappings may be denoted by Tₖ, where k is an index for identifying projectors 112. Based on the projector-to-camera mappings (Tₖ), the geometric mappings (Fₖ) between each projector 112 and hypothetical reference projector 118 are determined by calibration unit 124, and provided to sub-frame generator 108. For example, in a display system 100 with two projectors 112(1) and 112(2), assuming the first projector 112(1) is hypothetical reference projector 118, the geometric mapping of the second projector 112(2) to the first (reference) projector 112(1) can be determined as shown in the following Equation XXVII:

F₂=T₂T₁⁻¹ Equation XXVII
where:
   F₂=operator that maps a low-resolution sub-frame 110 of the second projector 112(2) to the
   first (reference) projector 112(1);
   Tᵢ=geometric mapping between the first projector 112(1) and camera 122; and
   T₂=geometric mapping between the second projector 112(2) and camera 122.

In one embodiment, the geometric mappings (Fᵢₖ) are determined once by calibration unit 124, and provided to sub-frame generator 108. In another embodiment, calibration unit 124 continually determines (e.g., once per frame 106) the geometric mappings (Fᵢₖ), and continually provides updated values for the mappings to sub-frame generator 108.

One embodiment provides an image display system 100 with multiple overlapped low-resolution projectors 112 coupled with an efficient real-time (e.g., video rates) image processing algorithm for generating sub-frames 110. In one embodiment, multiple low-resolution, low-cost projectors 112 are used to produce high resolution images at high lumen levels, but at lower cost than existing high-resolution projection systems, such as a single, high-resolution, high-output projector. One embodiment provides a scalable image display system 100 that can provide virtually any desired resolution, brightness, and color, by adding any desired number of component projectors 112 to the system 100.

In some existing display systems, multiple low-resolution images are displayed with temporal and sub-pixel spatial offsets to enhance resolution. There are some important differences between these existing systems and embodiments described herein. For example, in one embodiment, there is no need for circuitry to offset the projected sub-frames 110 temporally. In one embodiment, sub-frames 110 from the component projectors 112 are projected “in-sync”. As another example, unlike some existing systems where all of the sub-frames go through the same optics and the shifts between sub-frames are all simple translational shifts, in one embodiment, sub-frames 110 are projected through the different optics of the multiple individual projectors 112. In one embodiment, the signal processing model that is used to generate optimal sub-frames 110 takes into account relative geometric distortion among the component sub-frames 110, and is robust to minor calibration errors and noise.

It can be difficult to accurately align projectors into a desired configuration. In one embodiment, regardless of what the particular projector configuration is, even if it is not an optimal alignment, sub-frame generator 108 determines and generates optimal sub-frames 110 for that particular configuration.

Algorithms that seek to enhance resolution by offsetting multiple projection elements have been previously proposed. These methods may assume simple shift offsets between projectors, use frequency domain analyses, and rely on heuristic methods to compute component sub-frames. In contrast, one form of the embodiments described herein utilize an optimal real-time sub-frame generation algorithm that explicitly accounts for arbitrary relative geometric distortion (not limited to homographies) between the component projectors 112, including distortions that occur due to a display surface that is non-planar or has surface non-uniformities. One embodiment generates sub-frames 110 based on a geometric relationship between a hypothetical high-resolution hypothetical reference projector at any arbitrary location and each of the actual low-resolution projectors 112, which may also be positioned at any arbitrary location.

In one embodiment, system 100 includes multiple overlapped low-resolution projectors 112, with each projector 112 projecting a different colorant to compose a full color high-resolution image on the display surface with minimal color artifacts due to the overlapped projection. By imposing a color-prior model via a Bayesian approach as is done in one embodiment, the generated solution for determining sub-frame values minimizes color aliasing artifacts and is robust to small modeling errors.

Using multiple off the shelf projectors 112 in system 100 allows for high resolution. However, if the projectors 112 include a color wheel, which is common in existing projectors, the system 100 may suffer from light loss, sequential color artifacts, poor color fidelity, reduced bit-depth, and a significant tradeoff in bit depth to add new colors. One embodiment described herein eliminates the need for a color wheel, and uses in its place, a different color filter for each projector 112. Thus, in one embodiment, projectors 112 each project different single-color images. By not using a color wheel, segment loss at the color wheel is eliminated, which could be up to a 30% loss in efficiency in single chip projectors. One embodiment increases perceived resolution, eliminates sequential color artifacts, improves color fidelity since no spatial or temporal dither is required, provides a high bit-depth per color, and allows for high-fidelity color.

Image display system 100 is also very efficient from a processing perspective since, in one embodiment, each projector 112 only processes one color plane. Thus, each projector 112 reads and renders only one-third (for RGB) of the full color data.

In one embodiment, image display system 100 is configured to project images that have a three-dimensional (3D) appearance. In 3D image display systems, two images, each with a different polarization, are simultaneously projected by two different projectors. One image corresponds to the left eye, and the other image corresponds to the right eye. Conventional 3D image display systems typically suffer from a lack of brightness. In contrast, with one embodiment, a first plurality of the projectors 112 may be used to produce any desired brightness for the first image (e.g., left eye image), and a second plurality of the projectors 112 may be used to produce any desired brightness for the second image (e.g., right eye image). In another embodiment, image display system 100 may be combined or used with other display systems or display techniques, such as tiled displays.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An image display system comprising:
a first projector configured to project a first sub-frame onto a display surface to form at least a first portion of a first image;
a second projector configured to project a second sub-frame onto the display surface simultaneous with the projection of the first sub-frame to form at least a first portion of a second image, the second sub-frame at least partially overlapping with the first image on the display surface; and
a channel selection device configured to simultaneously allow a viewer to see the first image and prevent the viewer from seeing the second image.

2. The image display system of claim 1 wherein the channel selection device is configured to selectively allow the viewer to see either the first image or the second image.

3. The image display system of claim 1 wherein the channel selection device is configured to selectively prevent the viewer from seeing either the first image or the second image.

4. The image display system of claim 1 further comprising:
a third projector configured to project a third sub-frame onto the display surface simultaneous with the projection of the first sub-frame to form at least a second portion of the first image; and
a sub-frame generator configured to generate at least the first and the third sub-frame based on a first geometric relationship between a hypothetical reference projector and each of the first and the third projectors.

5. The image display system of claim 4 further comprising:
a fourth projector configured to project a fourth sub-frame onto the display surface simultaneous with the projection of the first sub-frame to form at least a second portion of the second image; and
wherein the sub-frame generator is configured to generate at least the second and the fourth sub-frame based on a second geometric relationship between the hypothetical reference projector and each of the second and the fourth projectors.

6. The image display system of claim 1 wherein the channel selection device includes a first projector comb filter configured to filter a first set of frequency ranges from the first projector, wherein the channel selection device includes a second projector comb filter configured to filter a second set of frequency ranges from the second projector, wherein the first set of frequency ranges differs from the second set of frequency ranges, and wherein the channel selection device includes a first viewer comb filter configured to filter the first set of frequency ranges.

7. The image display system of claim 6 wherein the first projector includes the first projector comb filter, and wherein the second projector includes the second projector comb filter.

8. The image display system of claim 6 wherein the channel selection device includes a second viewer comb filter configured to filter the second set of frequency ranges.

9. The image display system of claim 1 wherein the channel selection device includes a first polarizer configured to polarize the first image from the first projector using a first polarization, a second polarizer configured to polarize the second image from the second projector using a second polarization that is a complement of the first polarization.

10. The image display system of claim 1 wherein the channel selection device includes at least one shutter device.

11. The image display system of claim 1 wherein the channel selection device includes a lenticular array configured to direct the first image so that the viewer can see the first image and direct the second image so that the viewer cannot see the second image.

12. A method comprising:
displaying a first video stream on a display surface with at least a first projector to form a first set of displayed images;
displaying a second video stream on the display surface with at least a second projector simultaneous with displaying the first video stream to form a second set of displayed images, that second video stream at least partially overlapping with the first video stream on the display surface; and
providing a channel selection device configured to select at least one of the first set of displayed images and the second set of displayed images for viewing by a viewer.

13. The method of claim 12 further comprising:
displaying a third video stream on the display surface using at least a third projector simultaneous with displaying the first video stream such that third video stream at least partially overlaps with the first video stream on the display surface; and
wherein the channel selection device is configured to select at least one of the first video stream, the second video stream, and the third video stream for viewing.

14. The method of claim 12 further comprising:
filtering a first set of frequency ranges from the first video stream prior to the first set of displayed images appearing on the display surface; and
filtering a second set of frequency ranges from the second set of displayed images prior to the second video stream appearing on the display surface, the second set of frequency ranges differing from the first set of frequency ranges; and
filtering first set of frequency ranges from the first and the second sets of displayed images subsequent to the first and the second sets of displayed images appearing on the display surface.

15. The method of claim 12 further comprising:
polarizing the first video stream with a first polarization prior to the first set of displayed images appearing on the display surface; and
polarizing the second video stream with a second polarization that differs from the first polarization prior to the second set of displayed images appearing on the display surface; and
filtering the first and the second sets of displayed images with the first polarization subsequent to the first and the second sets of displayed images appearing on the display surface.

16. The method of claim 13 further comprising:
displaying the first video stream on the display surface with at least the first projector and a third projector using first and second sub-frames formed according to a geometric relationship between the first and the third projectors to form the first set of displayed images.

17. A system comprising:
a first set of projectors configured to project a first video stream onto a display surface;
a second set of projectors configured to project a second video stream onto the display surface so that the second video stream at least partially and simultaneously overlaps with the first video stream on the display surface; and
a channel selection device configured to allow one of a first channel that includes only the first video stream, a second channel that includes only the second video stream, and a third channel that includes both of the first video stream and the second video stream to be seen by a first viewer.

18. The system of claim 17 wherein the channel selection device is configured to selectively allow a different one of the first channel, the second channel, and the third channel to be seen by a second viewer.

19. The system of claim 17 further comprising:
a sub-frame generator;
wherein the first set of projectors includes at least two projectors,
wherein the a sub-frame generator is configured to generate a first plurality of sub-frames that form the first video stream according to a first geometric relationship between the first set of projectors, and wherein the first set of projectors are configured to simultaneously project the first plurality of sub-frames.

20. The system of claim 19 wherein the second set of projectors includes at least two projectors, wherein the a sub-frame generator is configured to generate a second plurality of sub-frames that form the second video stream according to a second geometric relationship between the second set of projectors, and wherein the second set of projectors are configured to simultaneously project the second plurality of sub-frames.
